(19) United States
(12) Patent Application Publication
(10) Pub. No.: US 2024/0182654 A1
(43) Pub. Date: Jun. 6, 2024

(54) FIBER REINFORCED THERMOPLASTIC COMPOSITE ARTICLES INCLUDING BIOMATERIALS

(71) Applicant: HANWHA AZDEL, INC., Forest, VA (US)

(72) Inventors: Liqing Wei, Forest, VA (US); Hongyu Chen, Forest, VA (US); Ruomiao Wang, Forest, VA (US); Dongjie Chen, Forest, VA (US)

(21) Appl. No.: 18/383,709

(22) Filed: Oct. 25, 2023

Related U.S. Application Data
(60) Provisional application No. 63/419,638, filed on Oct. 26, 2022.
(60) Provisional application No. 63/522,045, filed on Jun. 20, 2023.

(51) Int. Cl. C08J 5/04; C08J 9/00; C08K 5/00

(52) U.S. Cl. CPC C08J 5/045; C08J 5/043; C08J 9/0085; C08K 5/0058

(57) ABSTRACT

Thermoplastic composite articles are described that comprise biomaterials in one or more of a core layer and a skin layer. In certain arrangements, the thermoplastic composite article can include a porous core layer comprising a web of open celled structures comprising random crossing over of a plurality of reinforcing fibers held together by a thermoplastic material. The thermoplastic material can include virgin and recycled thermoplastic materials if desired. The web may also comprise biomaterials that can be bioparticles, biofibers or both. Exterior and interior components including the thermoplastic composite articles are also described.

### PRIORITY APPLICATIONS

This application claims priority to and the benefit of each of U.S. Provisional Application No. 63/419,638 filed on Oct. 26, 2022 and U.S. Provisional Application No. 63/522,045 filed on Jun. 20, 2023, the entire disclosure of each of which is hereby incorporated herein by reference.

### TECHNOLOGICAL FIELD

Fiber reinforced thermoplastic composite articles with biomaterials are described. In some configurations, the composite articles include a plurality of reinforcing fibers, a thermoplastic material and bioparticles and/or biofibers.

### BACKGROUND

Composite articles often include various materials that impart desired properties to the articles. The exact materials selected can depend on the intended use of the composite articles.

### SUMMARY

Certain aspects and features are described in reference to composite articles that can include biomaterials such as bioparticles in one or more layers of the composite article. In some embodiments, the biomaterials can be present on one or more of a core layer, a skin layer or both. If desired, the composite article can also include recycled thermoplastic materials in combination with the biomaterials.

In an aspect, a thermoplastic composite article comprises a porous core layer comprising a web of open celled structures comprising a plurality of biomaterials and random crossing over of a plurality of reinforcing fibers held together by a thermoplastic material, and a skin layer disposed on a first surface of the porous core layer. If desired, the plurality of reinforcing fibers comprise recycled or reclaimed fibers.

In certain embodiments, the plurality of biomaterials are bioparticles selected from the group consisting of particles from ground and sized rice hulls, coconut shells, coffee bean grounds, coffee chaff, wheat hulls, corn hulls, wood particles, plant byproducts and combinations thereof.

In other embodiments, the plurality of biomaterials are biofibers comprising fibers produced from one or more of ground and sized rice hulls, coconut shells, coffee bean grounds, coffee chaff, wheat hulls, corn hulls, wood particles, plant byproducts or combinations thereof.

In certain configurations, the thermoplastic material comprises thermoplastic material particles, and wherein the bioparticles comprises an average particle diameter about the same as an average particle diameter of the thermoplastic material particles. In other embodiments, average particle diameter is about 50 microns to about 2 mm.

In some configurations, the plurality of bioparticles comprise an inorganic content of at least 10 weight percent based on the weight of the plurality of bioparticles. In other embodiments, the plurality of bioparticles comprise silica. In some embodiments, the plurality of bioparticles are distributed homogeneously throughout the porous core layer or wherein the plurality of bioparticles impart a texture to the first surface of the porous core layer. In certain embodiments, the plurality of bioparticles are present in the porous core layer from about 1 weight percent to about 20 weight percent based on the weight of the porous core layer.

In some embodiments, the thermoplastic material of the porous core layer comprises a virgin polyolefin material or a recycled polyolefin material or both, the plurality of reinforcing fibers of the porous core layer comprise glass fibers, and the biomaterials of the porous core layer are bioparticles selected from the group consisting of particles from ground and sized rice hulls, coconut shells, coffee bean grounds, coffee chaff, wheat hulls, corn hulls, wood particles, plant byproducts and combinations thereof.

In other embodiments, the thermoplastic material of the porous core layer comprises virgin thermoplastic material, recycled thermoplastic material or both, and wherein the virgin thermoplastic material or recycled thermoplastic material is independently at least one of a polyethylene, a polypropylene, a polystyrene, a polyimide, a polyetherimide, an acrylonitrylstyrene, a butadiene, a polyethyleneterephthalate, a polybutyleneterephthalate, a polybutylenetetrachlorate, a polyvinyl chloride, a polyphenylene ether, a polycarbonate, a polyestercarbonate, a polyester, an acrylonitrile-butylacrylate-styrene polymer, an amorphous nylon, a polyarylene ether ketone, a polyphenylene sulfide, a polyaryl sulfone, a polyether sulfone, a poly(1,4 phenylene) compound, a silicone and mixtures thereof.

In certain embodiments, the plurality of reinforcing fibers of the porous core layer are selected from the group consisting of glass fibers, carbon fibers, graphite fibers, synthetic organic fibers, inorganic fibers, natural fibers, mineral fibers, metal fibers, metalized inorganic fibers, metalized synthetic fibers, ceramic fibers, reproduced fibers and combinations thereof.

In some configurations, the skin layer is selected from the group consisting of a fabric, a film, a scrim, a frim, a porous non-woven material, a porous knit material, a decorative layer, and combinations thereof.

In other configurations, the thermoplastic composite article is constructed and arranged as an interior automotive part, interior automotive trim, an automotive headliner, an interior recreational vehicle panel or an interior recreational vehicle part.

In other embodiments, the composite article can include a biocidal agent in the porous core layer. In certain embodiments, the composite article can include a lofting agent in the porous core layer.

In some examples, the skin layer comprises a plurality of biofibers.

In other examples, the plurality of biofibers in the skin layer are biofibers selected from the group consisting of fibers produced from ground and sized rice hulls, coconut shells, coffee bean grounds, coffee chaff, wheat hulls, corn hulls, wood particles, plant byproducts and combinations thereof.

In some embodiments, the thermoplastic material comprises a virgin polyolefin material or a recycled polyolefin material or both, the plurality of reinforcing fibers comprise biofibers, and the plurality of biomaterials are bioparticles selected from the group consisting of particles from ground and sized rice hulls, coconut shells, coffee bean grounds, coffee chaff, wheat hulls, corn hulls, wood particles, plant byproducts and combinations thereof.

In another aspect, a thermoplastic composite article comprises a porous core layer comprising a web of open celled structures comprising random crossing over of a plurality of reinforcing fibers and held together by a thermoplastic material, and a skin layer disposed on a first surface of the porous core layer, wherein the skin layer comprises a plurality of biofibers.

In certain embodiments, the plurality of biofibers of the skin layer are selected from the group consisting of fibers produced from ground and sized rice hulls, coconut shells, coffee bean grounds, coffee chaff, wheat hulls, corn hulls, wood particles, plant byproducts and combinations thereof. In some embodiments, the plurality of biofibers of the skin layer are present from 1 percent by weight of the skin layer up to 20 percent by weight of the skin layer.

In other embodiments, the thermoplastic material of the porous core layer comprises virgin thermoplastic material, recycled thermoplastic material or both, and wherein the virgin thermoplastic material or recycled thermoplastic material is independently at least one of a polyethylene, a polypropylene, a polystyrene, a polyimide, a polyetherimide, an acrylonitrylstyrene, a butadiene, a polyethylene terephthalate, a polybutylene terephthalate, a polybutylenetetrachlorate, a polyvinyl chloride, a polyphenylene ether, a polycarbonate, a polyestercarbonate, a polyester, an acrylonitrile-butylacrylate-styrene polymer, an amorphous nylon, a polyarylene ether ketone, a polyphenylene sulfide, a polyaryl sulfone, a polyether sulfone, a poly(1,4 phenylene) compound, a silicone and mixtures thereof.

In some examples, the plurality of reinforcing fibers of the porous core layer are selected from the group consisting of glass fibers, carbon fibers, graphite fibers, synthetic organic fibers, inorganic fibers, natural fibers, mineral fibers, metal fibers, metalized inorganic fibers, metalized synthetic fibers, ceramic fibers, reproduced fibers and combinations thereof.

In certain embodiments, the skin layer is selected from the group consisting of a fabric, a film, a scrim, a frim, a porous non-woven material, a porous knit material, a decorative layer, and combinations thereof.

In certain configurations, the plurality of reinforcing fibers in the porous core layer are present from 20 weight percent to 80 weight percent based on the weight of the porous core layer. In other embodiments, the plurality of biofibers of the skin layer are oriented in the skin layer at 15 degrees, 30 degrees, 45 degrees, 60 degrees, 75 degrees, or 90 degrees relative to a machine direction.

In certain embodiments, the thermoplastic composite article is constructed and arranged as a vehicular panel, a vehicular underbody panel, an exterior automotive part, an interior automotive part, an automotive headliner, a recreational vehicle panel or a recreational vehicle part.

In other embodiments, the plurality of thermoplastic material of the porous core layer comprises a virgin polyolefin material or a recycled polyolefin material or both, the plurality of reinforcing fibers of the porous core layer comprise glass fibers, and the biofibers of the skin layer are selected from the group consisting of fibers produced from ground and sized rice hulls, coconut shells, coffee bean grounds, coffee chaff, wheat hulls, corn hulls, wood particles, plant byproducts and combinations thereof.

In another aspect, a method of producing a thermoplastic composite article comprises adding a plurality of reinforcing fibers, a plurality of biomaterials and a thermoplastic material to an agitated aqueous foam to form a dispersed mixture, depositing the dispersed mixture of the plurality of reinforcing fibers, the biomaterials and the thermoplastic material onto a forming support element, evacuating liquid from the deposited, dispersed mixture to form a web, heating the web above a softening temperature of the thermoplastic material, compressing the heated web to a predetermined thickness, and disposing a skin layer on the compressed web to provide the thermoplastic composite article.

In certain embodiments, the plurality of biomaterials are bioparticles selected from the group consisting of particles from ground and sized rice hulls, coconut shells, coffee bean grounds, coffee chaff, wheat hulls, corn hulls, wood particles, plant byproducts and combinations thereof. In other embodiments, the plurality of biomaterials are biofibers selected from the group consisting of fibers produced from ground and sized rice hulls, coconut shells, coffee bean grounds, coffee chaff, wheat hulls, corn hulls, wood particles, plant byproducts and combinations thereof.

In some configurations, the skin layer comprises a plurality of biomaterials. In other configurations, the thermoplastic material comprises a mixture of virgin thermoplastic material and recycled thermoplastic material.

In an additional aspect, a method of producing a thermoplastic composite article comprises adding a plurality of reinforcing fibers and a thermoplastic material to an agitated aqueous foam to form a dispersed mixture, depositing the dispersed mixture of the plurality of reinforcing fibers and the thermoplastic material onto a forming support element, evacuating liquid from the deposited, dispersed mixture to form a web, heating the web above a softening temperature of the thermoplastic material, compressing the heated web to a predetermined thickness, and disposing a skin layer on the compressed web to provide the thermoplastic composite article, wherein the skin layer comprises a plurality of biomaterials.

In certain embodiments, the plurality of biomaterials of the skin layer are bioparticles selected from the group consisting of particles from ground and sized rice hulls, coconut shells, coffee bean grounds, coffee chaff, wheat hulls, corn hulls, wood particles, plant byproducts and combinations thereof. In some embodiments, the plurality of biomaterials of the skin layer are biofibers selected from the group consisting of fibers produced from ground and sized rice hulls, coconut shells, coffee bean grounds, coffee chaff, wheat hulls, corn hulls, wood particles, plant byproducts and combinations thereof. In other embodiments, the thermoplastic material comprises a mixture of virgin thermoplastic material and recycled thermoplastic material.

Additional aspects, embodiments, features and elements are described in more detail below.

### BRIEF DESCRIPTION OF THE SEVERAL VIEWS OF THE DRAWINGS

Certain specific illustrations are described in reference to the accompanying figures in which:

FIG. 1 is an illustration of a core layer comprising a thermoplastic material and biomaterials, in accordance with certain embodiments;

FIG. 2 is an illustration of a fiber reinforced thermoplastic composite article including a core layer comprising a thermoplastic material and biomaterials in combination with a skin layer, in accordance with certain embodiments;

FIG. 3 is an illustration of a fiber reinforced thermoplastic composite article including a core layer comprising a thermoplastic material and biomaterials in combination with two skin layers, in accordance with certain embodiments;

FIG. 4 is an illustration of a fiber reinforced thermoplastic composite article including a core layer comprising a thermoplastic material and biomaterials in combination with a decorative layer, in accordance with certain embodiments;

FIG. 5 is an illustration of a fiber reinforced thermoplastic composite article including a core layer comprising a thermoplastic material and reinforcing fibers in combination with a skin layer comprising biomaterials, in accordance with certain embodiments;

FIG. 6 is an illustration of a fiber reinforced thermoplastic composite article including a core layer comprising a thermoplastic material and reinforcing fibers in combination with a skin layer comprising biomaterials and another skin layer, in accordance with certain embodiments;

FIG. 7 is an illustration of a fiber reinforced thermoplastic composite article including a core layer comprising a thermoplastic material and reinforcing fibers in combination with a skin layer comprising biomaterials and a decorative layer, in accordance with certain embodiments;

FIG. 8 is an illustration of a core layer comprising a thermoplastic material and reproduced biomaterials coupled to a core layer comprising a thermoplastic material and reinforcing fibers, in accordance with certain embodiments;

FIG. 9 is an illustration of a core layer comprising a thermoplastic material and reproduced biomaterials coupled to a core layer comprising a thermoplastic material and reinforcing fibers in combination with a skin layer, in accordance with certain embodiments;

FIG. 10 is an illustration of a core layer comprising a thermoplastic material and reproduced biomaterials coupled to a core layer comprising a thermoplastic material and reinforcing fibers, in accordance with certain embodiments;

FIG. 11 is an illustration of a core layer comprising a thermoplastic material and reproduced biomaterials coupled to a core layer comprising a thermoplastic material and reinforcing fibers in combination with two skin layers, in accordance with certain embodiments;

FIG. 12 is an illustration of a core layer comprising a thermoplastic material and reproduced biomaterials coupled to a core layer comprising a thermoplastic material and reinforcing fibers in combination with a decorative layer, in accordance with certain embodiments;

FIG. 13 is an illustration of a core layer comprising a thermoplastic material and reproduced biomaterials coupled to a core layer comprising a thermoplastic material and reinforcing fibers through a skin layer, in accordance with certain embodiments;

FIG. 14 is an illustration of a headliner, in accordance with certain embodiments;

FIG. 15 is an illustration of interior trim, in accordance with certain embodiments;

FIG. 16 is an illustration of an interior trim, in accordance with certain embodiments;

FIG. 17 is an illustration of a ceiling panel, in accordance with certain embodiments;

FIG. 18 is an illustration of a cubicle panel, in accordance with certain embodiments;

FIG. 19 is an illustration of a structural panel, in accordance with certain embodiments;

FIG. 20 is another illustration of a structural panel, in accordance with certain embodiments;

FIG. 21 is an illustration of a wall panel, in accordance with certain examples;

FIG. 22 is an illustration of a siding panel, in accordance with certain examples;

FIG. 23 is an illustration of a roofing panel, in accordance with certain embodiments;

FIG. 24 is an illustration of a roofing shingle, in accordance with certain embodiments;

FIG. 25 is an illustration of an interior panel of a recreational vehicle, in accordance with certain embodiments;

FIG. 26 is an illustration of an exterior panel of a recreational vehicle, in accordance with certain embodiments;

FIG. 27 is an illustration of an automobile, in accordance with certain embodiments;

FIG. 28 is an illustration of a recreational vehicle, in accordance with certain embodiments;

FIG. 29 is an illustration of an airplane, in accordance with certain embodiments;

FIG. 30 is an illustration of a spacecraft, in accordance with certain embodiments; and

FIG. 31, FIG. 32, FIG. 33, FIG. 34, FIG. 35, FIG. 36, FIG. 37 and FIG. 38 show the results of testing of certain formulations;

FIG. 39, FIG. 40, FIG. 41, FIG. 42, FIG. 43, FIG. 44, FIG. 45 and FIG. 46 shows results from the formulations tested in Example 2;

FIG. 47, FIG. 48, FIG. 49, FIG. 50, FIG. 51, and FIG. 52 shows results from the formulations tested in Example 3; and

FIG. 53, FIG. 54, FIG. 55, FIG. 56, FIG. 57, FIG. 58, FIG. 59, FIG. 60 and FIG. 61 shows results from the formulations tested in Example 4.

It will be recognized by the person having ordinary skill in the art, given the benefit of this disclosure, that the dimensions, sizes, shading, arrangement and other features in the figures are provided merely for illustration and are not intended to limit the technology to any one configuration, dimension or arrangement.

### DETAILED DESCRIPTION

Various components and features of fiber reinforced thermoplastic composite articles that include biomaterials in one, two, three or more different components or layers are discussed. In some configurations, the biomaterials may be bioparticles, biofibers or combinations thereof. While the exact sizes of bioparticles and biofibers may overlap, bioparticles typically have a lower average diameter than a length of the biofibers. For example, bioparticles typically have an average diameter of less than 2 mm, whereas biofibers typically have a length of 2 mm or more. In some embodiments, the bioparticles may generally be spherical, e.g., have an aspect ratio (ratio of length to width) of about 1, whereas, biofibers typically have an aspect ratio or greater than 3, greater than 4, greater than 5, greater than 10 or even greater than 20. In some embodiments, the plurality of bioparticles comprise an inorganic content of at least 10 weight percent based on the weight of the plurality of bioparticles. In some embodiments, the plurality of bioparticles comprise silica.

In certain embodiments, the biomaterials may be particles produced from plant, animal or other biological waste products, e.g., can be produced from seed hairs, such as cotton; stem (or bast) fibers, such as flax and hemp; leaf fibers, such as sisal; and husk fibers, such as coconut. For example, the biomaterials can be produced from one or more of rice hulls, coconuts shells, coffee chaff, wheat hulls, corn hulls, wood particles, coffee bean grounds, plant byproducts and combinations thereof. In some embodiments, bioparticles can be produced from one or more of rice hulls, coconuts shells, coffee chaff, wheat hulls, corn hulls, wood particles, coffee bean grounds, plant byproducts and combinations thereof. In other embodiments, biofibers can be produced from one or more of rice hulls, coconuts shells, coffee chaff, wheat hulls, corn hulls, wood particles, coffee bean grounds, plant byproducts and combinations thereof.

In other embodiments, the biomaterials can be produced from egg shells, animal hair, animal bone, animal fat, animal meat, animal collagen, or other animal products and byproducts and combinations thereof. In some embodiments, bioparticles can be produced from egg shells, animal hair (wool, hair), insect secretions (e.g., silk), animal bone, animal fat, animal meat, animal collagen, or other animal products and byproducts and combinations thereof. In other embodiments, biofibers can be produced from one or more of egg shells, seashells, crab shell, shrimp shell, fish shell, animal hair, animal bone, animal fat, animal meat, animal collagen, or other animal products and byproducts and combinations thereof.

In some examples, the biomaterials can be produced from non-plant and non-animal products and byproducts including insects, fungus, arthropods, nematodes and combinations thereof. For example, bioparticles can be produced from non-plant and non-animal products and byproducts including insects, fungus, arthropods, nematodes and combinations thereof. In certain examples, biofibers can be produced from non-plant and non-animal products and byproducts including insects, fungus, arthropods, nematodes and combinations thereof.

In certain embodiments, where bioparticles are present, an average particle size of the bioparticles can vary from about 50 microns to about 2 mm. In some embodiments, the bioparticles can have an average particle size, e.g., an average particle diameter, that is about the same, e.g., varies by less than 5%, as an average particle size of the thermoplastic material present in the composite articles. As noted herein, the bioparticles can have an aspect ratio of about 1, about 2 or an aspect ratio of less than 3. In certain embodiments, where biofibers are present, the exact size of biofibers may vary. For example, the biofibers can generally have a diameter of greater than about 5 microns, e.g., 5-400 or 200-400 or 10-200 microns, more particularly from about 5 microns to about 22 microns, and a length of from about 5 mm to about 3 meters, for example about 5 mm to about 200 mm, 1 meter to about 3 meters, 100 cm to about 200 cm, more particularly, the biofiber diameter may be from about 2 microns to about 22 microns and the biofiber length may be from about 5 mm to about 75 mm. For plant based biofibers, the diameter typically is 10-400 microns. For animal fibers, the diameter can typically be 5-20 microns and a length from 2.5 cm up to 10 meters or even from 500-1500 meters in the case of silk. The biofibers may be twisted as a result of the fiber production process or can be untwisted and present as single biofibers which generally do not cross over or intersect with other biofibers. Without wishing to be bound by any particular configuration, untwisted biofibers may provide smoother surfaces than twisted biofibers. The biofibers are typically randomly oriented when present in the thermoplastic composite articles described herein, though if desired, the biofibers could be oriented in suitable directions, e.g., at 0 degrees, 15 degrees, 30 degrees, 45 degrees, 60 degrees, 75 degrees or 90 degrees, relative to a machine direction used to produce the thermoplastic composite articles. The biofibers typically have an aspect ratio (length to width ratio) of greater than 3, greater than 4, greater than 5, greater than 10 or even greater than 20 or greater than 50.

In certain embodiments, the bioparticles and biofibers can be produced by crushing, grinding, milling and/or sizing the biomaterials. For example, plant or animal waste byproducts can be cleaned, ground, crushed, milled, filtered and/or sized to provide bioparticles or biofibers of a desired size. The bioparticles can include a single biomaterial or multiple different biomaterials as desired.

In other embodiments, the thermoplastic composite article can include one or more recycled thermoplastic materials. The recycled thermoplastic materials can be used in combination with the biomaterials or may be used in combination with biomaterials and other materials, e.g., glass fibers, inorganic fibers, organic fibers, polymeric fibers, etc. In some configurations, the thermoplastic materials present in a composite article may be a combination of virgin thermoplastic material and recycled thermoplastic material. For example, virgin polyolefin material can be mixed with recycled polyolefin material and the mixture can be used to produce a fiber reinforced thermoplastic composite article as described herein.

In some embodiments, the recycled thermoplastic material may be chemically similar or the same as the virgin thermoplastic material but may be physically different than the virgin thermoplastic material. For example, the recycled thermoplastic material may have a different color, particle size, shape, average glass transition temperature, crystallinity or other physical characteristics that are different than the virgin thermoplastic material even though the virgin thermoplastic material and the recycled thermoplastic material share the same underlying chemistry.

In some embodiments, the virgin thermoplastic material and the recycled thermoplastic material each comprise polyolefin materials, which can be the same or can be different. For example, each of the virgin and recycled thermoplastic materials can be a polyethylene (e.g., high density polyethylene, low density polyethylene, linear low density polyethylene), a polypropylene (e.g., homopolymer, random copolymer, and block copolymer), polybutene (e.g., 1-butene, 2-butene, and isobutylene) and other copolymers thereof. In some instances, the recycled polyolefin may comprise a blend of different recycled polyolefins, e.g., a blend or mixture of polyethylene and polypropylene.

In other configurations, the recycled thermoplastic material can be recycled polystyrene, recycled acrylonitrylstyrene, recycled butadiene, recycled polyethyleneterephthalate, recycled polybutyleneterephthalate, recycled polybutylenetetrachlorate, and recycled polyvinyl chloride, both plasticized and unplasticized, and blends of these materials with each other or other polymeric materials. Other suitable recycled thermoplastics include, but are not limited to, recycled polyarylene ethers, recycled polycarbonates, recycled polyestercarbonates, recycled thermoplastic polyesters, recycled polyimides, recycled polyetherimides, recycled polyamides, recycled co-polyamides, recycled acrylonitrile-butylacrylate-styrene polymers, recycled amorphous nylon, recycled polyarylene ether ketone, recycled polyphenylene sulfide, recycled polyaryl sulfone, recycled polyether sulfone, recycled liquid crystalline polymers, recycled poly(1,4 phenylene) compounds commercially known as PARMAX®, recycled high heat polycarbonate such as Bayer's APEC® PC, recycled high temperature nylon, and recycled silicones, as well as copolymers, alloys and blends of these materials with each other or other polymeric materials. The recycled thermoplastic material used to form the core layer can be used in powder form, resin form, rosin form, particle form, fiber form or other suitable forms.

In certain embodiments, the exact total amount of thermoplastic material (virgin, recycled or both) present in the core layer can vary and illustrative amounts range from about 20% by weight to about 80% by weight, e.g., 30-70 percent by weight or 35-65 percent by weight, based on the total weight of the core layer.

In other instances, all of the thermoplastic material in the composite article may be recycled thermoplastic material. Such recycled thermoplastic material can be used with biomaterials and non-biomaterials as desired.

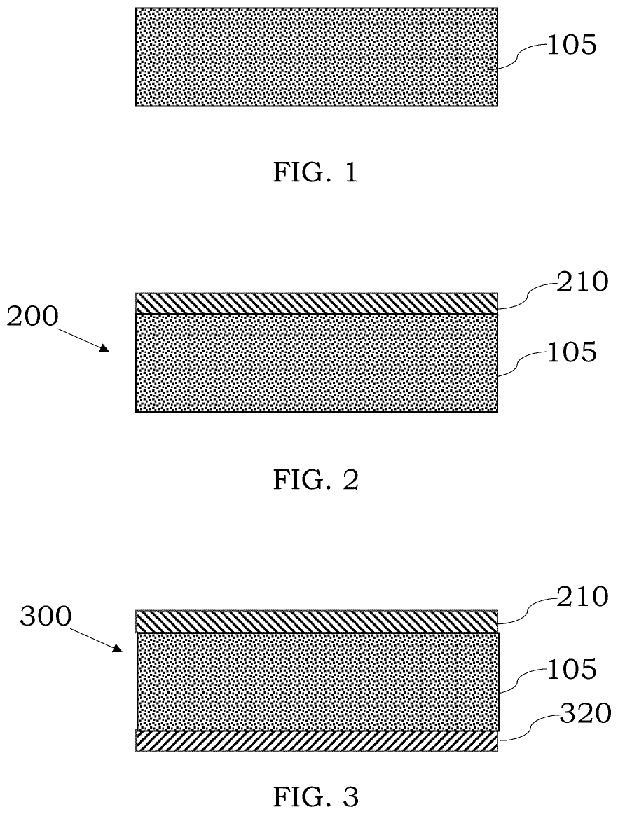

In certain configurations, a fiber reinforced thermoplastic composite article can include a porous core layer comprising a web of open celled structures comprising random crossing over of a plurality of reinforcing fibers held together by a thermoplastic material, which can be virgin thermoplastic material, recycled thermoplastic material or combinations thereof. Biomaterials may be present in the core layer as noted herein. Referring to FIG. 1, a core layer 105 is shown that comprises biomaterials, e.g., bioparticles or biofibers, and the thermoplastic material. The core layer 105 is typically porous, e.g., is a porous core layer, with a porosity that can vary from more than 0% by volume up to about 95% by volume of the porous core layer. For example, the porous core layer 105 may comprise a void content or porosity of 0-30%, 10-40%, 20-50%, 30-60%, 40-70%, 50-80%, 60-90%, 0-40%, 0-50%, 0-60%, 0-70%, 0-80%, 0-90%, 10-50%, 10-60%, 10-70%, 10-80%, 10-90%, 10-95%, 20-60%, 20-70%, 20-80%, 20-90%, 20-95%, 30-70%, 30-80%, 30-90%, 30-95%, 40-80%, 40-90%, 40-95%, 50-90%, 50-95%, 60-95% 70-80%, 70-90%, 70-95%, 80-90%, 80-95% by volume of the porous core layer or any illustrative value within these exemplary ranges.

In certain embodiments, the thermoplastic material of the porous core layer 105 can include polyolefin (virgin or recycled) and/or non-polyolefin materials. For example, the thermoplastic material of the core layer 105 comprises one or more of a virgin or recycled or both polyolefin (e.g., one or more of polyethylene, polypropylene, etc.), polystyrene, acrylonitrylstyrene, butadiene, polyethyleneterephthalate, polybutyleneterephthalate, polybutylenetetrachlorate, and polyvinyl chloride, both plasticized and unplasticized, and blends of these materials with each other or other polymeric materials. Other suitable thermoplastics include, but are not limited to, polyarylene ethers, polycarbonates, polyestercarbonates, thermoplastic polyesters, polyimides, polyetherimides, polyamides, co-polyamides, acrylonitrile-butylacrylate-styrene polymers, amorphous nylon, polyarylene ether ketone, polyphenylene sulfide, polyaryl sulfone, polyether sulfone, liquid crystalline polymers, poly(1,4 phenylene) compounds commercially known as PARMAX®, high heat polycarbonate such as Bayer's APEC® PC, high temperature nylon, and silicones, as well as copolymers, alloys and blends of these materials with each other or other polymeric materials. The thermoplastic material used to form the core layer 105 can be used in powder form, resin form, rosin form, particle form, fiber form or other suitable forms. Illustrative thermoplastic materials in various forms are described herein and are also described, for example in U.S. Publication Nos. 20130244528 and US20120065283. The exact amount of thermoplastic material present in the core layer can vary and illustrative amounts range from about 20% by weight to about 80% by weight, e.g., 30-70 percent by weight or 35-65 percent by weight, based on the total weight of the core layer 105. It will be recognized by the skilled person that the weight percentages of all materials used in the core layer 105 will add to 100 weight percent. The thermoplastic material in the core layer 105 can include only virgin material, only recycled material, or a combination of a virgin material and recycled material. Where a combination of virgin and recycled thermoplastic material are used, the recycled material can be chemically the same or different than the virgin material. Where the recycled material is chemically the same as the virgin material, the recycled material may be physically different than the virgin material, e.g., the recycled material may have a different color, particle size, shape, average glass transition temperature, crystallinity or other physical characteristics that are different than the virgin thermoplastic material even though the virgin thermoplastic material and the recycled thermoplastic material share the same underlying chemistry.

In certain configurations, the exact amount of biomaterials present in the core layer 105 can vary. For example, where bioparticles are present in a core layer 105, the bioparticles can act as a filler material and may be present at less than 50% by weight of the core layer 105. The bioparticles in the core layer 105 can include one or more of particles produced from plant byproducts, animal byproducts or combinations thereof. For example, the bioparticles in the core layer 105 can be produced from one or more of rice hulls, coconuts shells, coffee chaff, wheat hulls, corn hulls, wood particles, coffee bean grounds, plant byproducts and combinations thereof. In other embodiments, the bioparticles in the core layer 105 can be produced from egg shells, animal hair, animal bone, animal fat, animal meat, animal collagen, or other animal products and byproducts and combinations thereof. In embodiments where the biomaterial is a biofiber, the biofiber may be present from 20 weight percent to 80 weight percent based on the weight of the core layer 105. The biofibers in the core layer 105 can include one or more of fibers produced from plant byproducts, animal byproducts or combinations thereof. For example, the biofibers in the core layer 105 can be produced from one or more of rice hulls, coconuts shells, coffee chaff, wheat hulls, corn hulls, wood particles, coffee bean grounds, plant byproducts and combinations thereof. In other embodiments, the biofibers in the core layer 105 can be produced from egg shells, animal hair, animal bone, animal fat, animal meat, animal collagen, or other animal products and byproducts and combinations thereof. If desired, both bioparticles and biofibers can be present in the core layer 105. In certain configurations, the plurality of bioparticles comprise an inorganic content of at least 10 weight percent based on the weight of the plurality of bioparticles. In some instances, the plurality of bioparticles comprise silica. In some embodiments, the plurality of bioparticles are distributed homogeneously throughout the porous core layer 105. In other embodiments, he plurality of bioparticles impart a texture to the first surface of the porous core layer 105.

In certain embodiments, the porous core layer 105 can also include reinforcing fibers. In some embodiments, the biofibers may be the only fibers present in the core layer 105, whereas in other examples, biofibers and reinforcing fibers may both be present. For example, the reinforcing fibers in the core layer 105 may comprise glass fibers, carbon fibers, graphite fibers, synthetic organic fibers, particularly high modulus organic fibers such as, for example, para- and meta aramid fibers, nylon fibers, polyester fibers, natural fibers, cellulose fibers, a high melt flow index resin (e.g., 100 g/10 min. MFI, 325 g/10 min. MFI or above) that is suitable for use as fibers, mineral fibers such as basalt, mineral wool (e.g., rock or slag wool), wollastonite, alumina silica, and the like, or mixtures thereof, metal fibers, metalized natural and/or synthetic fibers, ceramic fibers, yarn fibers, or mixtures thereof. In some configurations, the fibers may comprise reproduced or reclaimed fibers including reproduced polymeric fibers or reproduced glass fibers, e.g., fibers which have been recycled and/or reclaimed with optional physical and/or chemical treatment prior to reuse. In certain embodiments, the reinforcing fibers used in the core layer 105 may be cellulose free. In some embodiments, the reinforcing fibers in the core layer 105 can be bi-component fibers, e.g., core-sheath fibers, as described for example, in U.S. Patent Publication No. 20180162107 published on Jun. 14, 2018. In some embodiments, any of the aforementioned fibers can be chemically treated prior to use to provide desired functional groups or to impart other physical properties to the fibers, e.g., may be chemically treated so that they can react with the thermoplastic material. The reinforcing fiber content in the core layer may vary from about 10% to about 90% by weight of the core layer, more particularly from about 20% to about 80% by weight, e.g., about 30% to about 70% by weight of the core layer 105. The particular size and/or orientation of the reinforcing fibers used may depend, at least in part, on the thermoplastic material used and/or the desired properties of the core layer 105. For example, the reinforcing fibers can be randomly oriented or may have a specific selected orientation as desired. In one non-limiting illustration, reinforcing fibers dispersed within a thermoplastic material and optionally other additives to provide the core layers can generally have a diameter of greater than about 5 microns, more particularly from about 5 microns to about 22 microns, and a length of from about 5 mm to about 200 mm, more particularly, the fiber diameter may be from about 2 microns to about 22 microns and the fiber length may be from about 5 mm to about 75 mm. Where reinforcing fibers are present in combination with biofibers, the total fiber content in the core layer 105 may vary from about 10% to about 90% by weight of the core layer, more particularly from about 20% to about 80% by weight of the core layer, e.g., about 30% to about 70% by weight of the core layer 105.

In some embodiments, the core layer can include only recycled thermoplastic material (no virgin thermoplastic material) and only biomaterials. Such articles meet sustainability requirements by including large amounts of recycled thermoplastic and biomaterials.

In some embodiments, other additives or materials may also be present in the core layer 105. Such additives may be virgin additive or recycled additives. For example, antimicrobial agents, antifungal agents, biocidal agents, a lofting agent, flame retardants, colorants, smoke suppressants, surfactants, foams or other materials may be present. In some examples, the core layer 105 may substantially halogen free or halogen free core layer to meet the restrictions on hazardous substances requirements for certain applications. In other instances, the core layer may comprise a halogenated flame retardant agent such as, for example, a halogenated flame retardant that comprises one of more of F, Cl, Br, I, and At or compounds that including such halogens, e.g., tetrabromo bisphenol-A polycarbonate or monohalo-, dihalo-, trihalo- or tetrahalo-polycarbonates. In some instances, the thermoplastic material used in the core layer 105 may comprise one or more halogens to impart some flame retardancy without the addition of another flame retardant agent. Where halogenated flame retardants are present, the flame retardant is desirably present in a flame retardant amount, which can vary depending on the other components which are present. For example, the halogenated flame retardant may be present in about 0.1 weight percent to about 15 weight percent (based on the weight of the core layer), more particularly about 1 weight percent to about 15 weight percent, e.g., about 5 weight percent to about 15 weight percent based on the weight of the core layer. If desired, two different halogenated flame retardants may be added to the layers. In other instances, a non-halogenated flame retardant agent such as, for example, a flame retardant agent comprising one or more of N, P, As, Sb, Bi, S, Se, and Te can be added. In some embodiments, the non-halogenated flame retardant may comprise a phosphorated material so the layers may be more environmentally friendly. Where non-halogenated or substantially halogen free flame retardants are present, the flame retardant is desirably present in a flame retardant amount, which can vary depending on the other components which are present. For example, the substantially halogen free flame retardant may be present in about 0.1 weight percent to about 15 weight percent (based on the weight of the layer), more particularly about 1 weight percent to about 15 weight percent, e.g., about 5 weight percent to about 15 weight percent based on the weight of the core layer. If desired, two different substantially halogen free flame retardants may be added to one or more of the core layers described herein. In certain instances, one or more of the core layers described herein may comprise one or more halogenated flame retardants in combination with one or more substantially halogen free flame retardants. Where two different flame retardants are present, the combination of the two flame retardants may be present in a flame retardant amount, which can vary depending on the other components which are present. For example, the total weight of flame retardants present may be about 0.1 weight percent to about 20 weight percent (based on the weight of the layer), more particularly about 1 weight percent to about 15 weight percent, e.g., about 2 weight percent to about 14 weight percent based on the weight of the core layer. The flame retardant agents used in the layers described herein can be added to the mixture comprising the thermoplastic material and fibers (prior to disposal of the mixture on a wire screen or other processing component) or can be added after the core layer 105 is formed. In some examples, the flame retardant material may comprise one or more of expandable graphite materials, magnesium hydroxide (MDH) and aluminum hydroxide (ATH).

In some embodiments, a lofting capacity of the core layer 105 can be tuned by including one or more added lofting agents in the core layer 105. The exact type of lofting agent used in the core layer 105 can depend on numerous factors including, for example, the desired lofting temperature, the desired degree of loft, etc. In some instances, microsphere lofting agents, e.g., expandable microspheres, which can increase their size upon exposure to convection heating may be used. Illustrative commercially available lofting agents are available, for example, from Kurcha Corp. (Japan). In other examples, the lofting agent may be an expandable graphite material or a combination of a microsphere lofting agent with a non-microsphere lofting agent.

In some configurations, a fiber reinforced thermoplastic composite article 200 can include the porous core layer 105 in combination with a skin layer 210 as shown in FIG. 2. The skin layer 210 may comprise a single layer of material or multiple layers of different materials as desired. In some embodiments, the skin layer 210 may comprise, for example, a film (e.g., thermoplastic film or elastomeric film), a frim, a scrim (e.g., fiber based scrim), a foil, a woven fabric, a non-woven fabric or be present as an inorganic coating, an organic coating, or a thermoset coating disposed on the core layer 105. In some examples, the skin layer 210 may comprise bioparticles, biofibers, natural fibers, polymeric fibers, inorganic fibers, or other materials. In other instances, the skin layer 210 may comprise a limiting oxygen index greater than about 22, as measured per ISO 4589 dated 1996. Where a thermoplastic film is present as (or as part of) the skin layer 210, the thermoplastic film may comprise at least one of poly(ether imide), poly(ether ketone), poly(ether-ether ketone), poly(phenylene sulfide), poly(arylene sulfone), poly(ether sulfone), poly(amide-imide), poly(1,4-phenylene), polycarbonate, nylon, a polyolefin (e.g., polyethylene, polypropylene, etc.) and silicone. The film can include virgin materials, recycled materials or both. Where a fiber based scrim is present as (or as part of) the skin layer 210, the fiber based scrim may comprise at least one of glass fibers, aramid fibers, graphite fibers, carbon fibers, inorganic mineral fibers, metal fibers, metalized synthetic fibers, and metalized inorganic fibers. The fiber based scrim can include virgin materials, recycled materials or both. Where a thermoset coating is present as (or as part of) the skin layer 210, the coating may comprise at least one of unsaturated polyurethanes, vinyl esters, phenolics and epoxies. The thermoset coating can include virgin materials, recycled materials or both. Where an inorganic coating is present as (or as part of) the skin layer 210, the inorganic coating may comprise minerals containing cations selected from Ca, Mg. Ba, Si, Zn, Ti and Al or may comprise at least one of gypsum, calcium carbonate and mortar. The inorganic coating can include virgin materials, recycled materials or both. Where a non-woven fabric is present as (or as part of) the skin layer 210, the non-woven fabric may comprise a thermoplastic material, a thermal setting binder, inorganic fibers, metal fibers, metallized inorganic fibers and metallized synthetic fibers. The non-woven fabric can include virgin materials, recycled materials or both. Where the skin layer 210 comprises biofibers, the biofibers in the skin layer 210 can include one or more of fibers produced from plant byproducts, animal byproducts or combinations thereof. For example, the biofibers in the skin layer 210 can be produced from one or more of rice hulls, coconuts shells, coffee chaff, wheat hulls, corn hulls, wood particles, coffee bean grounds, plant byproducts and combinations thereof. Recycled biofibers can also be present if desired. In other embodiments, the biofibers in the skin layer 210 can be produced from egg shells, animal hair, animal bone, animal fat, animal meat, animal collagen, or other animal products and byproducts and combinations thereof. The exact amount of bioparticles or biofibers in the skin layer 210 may vary from about 5% by weight to about 90% by weight, more particularly about 5% by weight to about 80% by weight of the skin layer, e.g., about 5-20% by weight, 5-30% by weight, 5-40% by weight, 5-50% by weight, 5-60% by weight, 10-60% by weight, 10-50% by weight, 20-50% by weight, 20-40% by weight or about 20 weight percent to about 80 weight percent or other amounts. If desired, both bioparticles and biofibers can be present in the skin layer 210.

In some embodiments, an adhesive layer (not shown) may optionally be present between the skin layer 210 and the core layer 105. In instances where an adhesive is desirable, one or more thermoplastic polymer adhesives may be used. For example, it may be desirable to couple the skin layer 210 to the core layer 105 using an adhesive. In some examples, the thermoplastic component of the adhesive layer may comprise a thermoplastic polymer such as, for example, a polyolefin such as a polyethylene or a polypropylene. The thermoplastic component of the adhesive layer can include recycled thermoplastic materials if desired. In other instances, the thermoplastic polymer of the adhesive layer may comprise, polystyrene, acrylonitrylstyrene, butadiene, polyethyleneterephthalate, polybutyleneterephthalate, polybutylenetetrachlorate, and polyvinyl chloride, both plasticized and unplasticized, and blends of these materials with each other or other polymeric materials. Other suitable thermoplastic polymers for use in the adhesive layer include, but are not limited to, polyarylene ethers, polycarbonates, polyestercarbonates, thermoplastic polyesters, polyimides, polyetherimides, polyamides, acrylonitrile-butylacrylate-styrene polymers, amorphous nylon, polyarylene ether ketone, polyphenylene sulfide, polyaryl sulfone, polyether sulfone, liquid crystalline polymers, poly(1,4 phenylene) compounds commercially known as PARMAX®, high heat polycarbonate such as Bayer's APEC® PC, high temperature nylon, and silicones, as well as alloys and blends of these materials with each other or other polymeric materials. If desired, the adhesive may also comprise some thermosetting material including, but not limited to, epoxides, epoxy resins, polyesters, polyester resins, urethanes, polyurethanes, diallyl-phthalates, polyamides, cyanate esters, polycyanurates and combinations thereof. In certain embodiments, the adhesive can also include recycled materials and/or biomaterials as desired.

In other configurations, a fiber reinforced thermoplastic composite article 300 can include the porous core layer 105 in combination with a skin layer 210 and a skin layer 320 as shown in FIG. 3. The skin layers 210, 320 can be the same or can be different. In certain embodiments, the skin layers 210, 320 may have common materials but different thicknesses or porosities. In some configurations, at least one of the skin layers 210, 320 comprises biofibers or bioparticles. In other configurations, each of the skin layers 210, 320 comprises biofibers or bioparticles. If desired, at least one of the skin layers 210, 320 can include both biofibers and bioparticles. In some instances, one or both of the skin layers can include recycled thermoplastic materials.

In certain embodiments, the skin layer 320 may comprise a single layer of material or multiple layers of different materials as desired. In some embodiments, the skin layer 320 may comprise, for example, a film (e.g., thermoplastic film or elastomeric film), a frim, a scrim (e.g., fiber based scrim), a foil, a woven fabric, a non-woven fabric or be present as an inorganic coating, an organic coating, or a thermoset coating disposed on the core layer 105. In some examples, the skin layer 320 may comprise natural fibers, polymeric fibers, biofibers as described herein or other materials. In other instances, the skin layer 320 may comprise a limiting oxygen index greater than about 22, as measured per ISO 4589 dated 1996. Where a thermoplastic film is present as (or as part of) the skin layer 320, the thermoplastic film may comprise at least one of poly(ether imide), poly(ether ketone), poly(ether-ether ketone), poly(phenylene sulfide), poly(arylene sulfone), poly(ether sulfone), poly(amide-imide), poly(1,4-phenylene), polycarbonate, nylon, a polyolefin (e.g., polyethylene, polypropylene, etc.) and silicone. The film can include virgin materials, recycled materials or both. Where a fiber based scrim is present as (or as part of) the skin layer 320, the fiber based scrim may comprise at least one of glass fibers, aramid fibers, graphite fibers, carbon fibers, inorganic mineral fibers, metal fibers, metalized synthetic fibers, and metalized inorganic fibers. The fiber based scrim can include virgin materials, recycled materials or both. Where a thermoset coating is present as (or as part of) the skin layer 320, the coating may comprise at least one of unsaturated polyurethanes, vinyl esters, phenolics and epoxies. The thermoset can include virgin materials, recycled materials or both. Where an inorganic coating is present as (or as part of) the skin layer 320, the inorganic coating may comprise minerals containing cations selected from Ca, Mg, Ba, Si, Zn, Ti and Al or may comprise at least one of gypsum, calcium carbonate and mortar. The inorganic coating can include virgin materials, recycled materials or both. Where a non-woven fabric is present as (or as part of) the skin layer 320, the non-woven fabric may comprise a thermoplastic material, a thermal setting binder, inorganic fibers, metal fibers, metallized inorganic fibers and metallized synthetic fibers. The non-woven fabric can include virgin materials, recycled materials or both. Where the skin layer 320 comprises biofibers, the biofibers in the skin layer 210 can include one or more of fibers produced from plant byproducts, animal byproducts or combinations thereof. For example, the biofibers in the skin layer 320 can be produced from one or more of rice hulls, coconuts shells, coffee chaff, wheat hulls, corn hulls, wood particles, coffee bean grounds, plant byproducts and combinations thereof. In other embodiments, the biofibers in the skin layer 320 can be produced from egg shells, animal hair, animal bone, animal fat, animal meat, animal collagen, or other animal products and byproducts and combinations thereof. Recycled biofibers can also be present if desired. The exact amount of bioparticles or biofibers in the skin layer 320 may vary from about 5% by weight to about 90% by weight, more particularly about 5% by weight to about 80% by weight of the skin layer, e.g., about 5-20% by weight, 5-30% by weight, 5-40% by weight, 5-50% by weight, 5-60% by weight, 10-60% by weight, 10-50% by weight, 20-50% by weight, 20-40% by weight or about 20 weight percent to about 80 weight percent or other amounts. If desired, both bioparticles and biofibers can be present in the skin layer 320.

In certain embodiments, an adhesive layer (not shown) may optionally be present between the skin layer 320 and the core layer 105. The adhesive layer may comprise recycled thermoplastic materials if desired. In instances where an adhesive is desirable, one or more thermoplastic polymer adhesives may be used. For example, it may be desirable to couple the skin layer 320 to the core layer 105 using an adhesive. In some examples, the thermoplastic component of the adhesive layer may comprise a thermoplastic polymer such as, for example, a polyolefin such as a polyethylene or a polypropylene. In other instances, the thermoplastic polymer of the adhesive layer may comprise, polystyrene, acrylonitrylstyrene, butadiene, polyethyleneterephthalate, polybutyleneterephthalate, polybutylenetetrachlorate, and polyvinyl chloride, both plasticized and unplasticized, and blends of these materials with each other or other polymeric materials. Other suitable thermoplastic polymers for use in the adhesive layer include, but are not limited to, polyarylene ethers, polycarbonates, polyestercarbonates, thermoplastic polyesters, polyimides, polyetherimides, polyamides, acrylonitrile-butylacrylate-styrene polymers, amorphous nylon, polyarylene ether ketone, polyphenylene sulfide, polyaryl sulfone, polyether sulfone, liquid crystalline polymers, poly(1,4 phenylene) compounds commercially known as PARMAX®, high heat polycarbonate such as Bayer's APEC® PC, high temperature nylon, and silicones, as well as alloys and blends of these materials with each other or other polymeric materials. If desired, the adhesive may also comprise some thermosetting material including, but not limited to, epoxides, epoxy resins, polyesters, polyester resins, urethanes, polyurethanes, diallyl-phthalates, polyamides, cyanate esters, polycyanurates and combinations thereof.

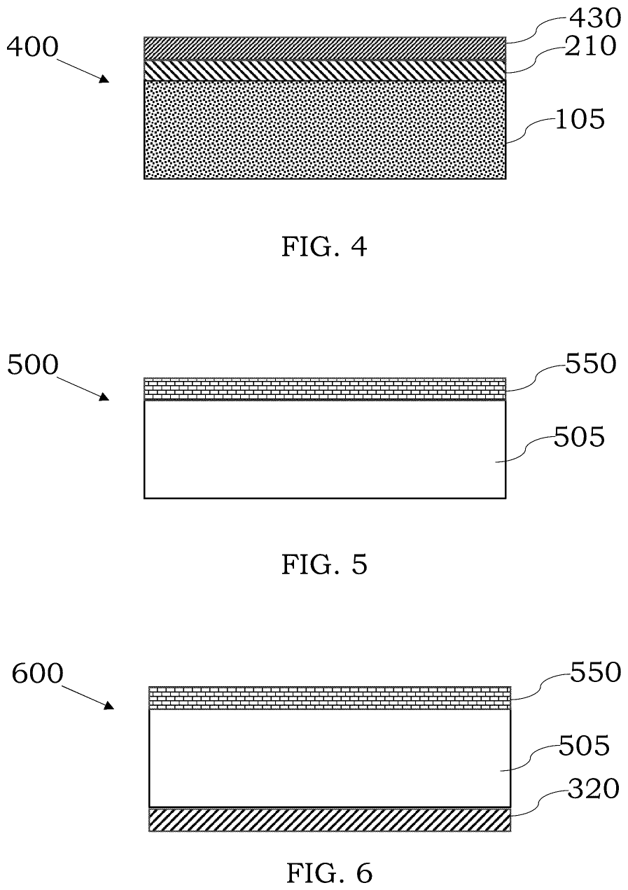

In certain configurations, a fiber reinforced thermoplastic composite article 400 can include the porous core layer 105 in combination with a skin layer 210 and a decorative layer 430 as shown in FIG. 4. The decorative layer 430 can be disposed directly on the porous core layer 105 or a skin layer may be present between the decorative layer 430 and the porous core layer 105 as desired. In certain embodiments, the decorative layer 430 may be formed, e.g., from a thermoplastic film of polyvinyl chloride, polyolefins, thermoplastic polyesters, thermoplastic elastomers, paper, or the like. The film can include virgin materials, recycled materials or both. The decorative layer 430 may also be a multi-layered structure if desired. For example, a fabric may be bonded to a foam core (or other structures), such as woven fabrics made from natural and synthetic fibers, organic fiber non-woven fabric after needle punching or the like, raised fabric, knitted goods, flocked fabric, or other such materials. The fabric may also be bonded to with a thermoplastic adhesive, including pressure sensitive adhesives and hot melt adhesives, such as polyamides, modified polyolefins, urethanes and polyolefins. The decorative layer 430 may also be produced using spunbond, thermal bonded, spun lace, melt-blown, wet-laid, and/or dry-laid processes. In some embodiments, the decorative layer 430 may be embossed, textured or otherwise include some pattern or grain structure.

In some embodiments, an adhesive layer (not shown) may optionally be present between the decorative layer 430 and the core layer 105. In instances where an adhesive is desirable, one or more thermoplastic polymer adhesives may be used. For example, it may be desirable to couple the decorative layer 430 to the core layer 105 using an adhesive. In some examples, the thermoplastic component of the adhesive layer may comprise a thermoplastic polymer such as, for example, a polyolefin such as a polyethylene or a polypropylene. The adhesive layer may comprise recycled thermoplastic materials if desired. In other instances, the thermoplastic polymer of the adhesive layer may comprise, polystyrene, acrylonitrylstyrene, butadiene, polyethyleneterephthalate, polybutyleneterephthalate, polybutylenetetrachlorate, and polyvinyl chloride, both plasticized and unplasticized, and blends of these materials with each other or other polymeric materials. Other suitable thermoplastic polymers for use in the adhesive layer include, but are not limited to, polyarylene ethers, polycarbonates, polyestercarbonates, thermoplastic polyesters, polyimides, polyetherimides, polyamides, acrylonitrile-butylacrylate-styrene polymers, amorphous nylon, polyarylene ether ketone, polyphenylene sulfide, polyaryl sulfone, polyether sulfone, liquid crystalline polymers, poly(1,4 phenylene) compounds commercially known as PARMAX®, high heat polycarbonate such as Bayer's APEC® PC, high temperature nylon, and silicones, as well as alloys and blends of these materials with each other or other polymeric materials. If desired, the adhesive may also comprise some thermosetting material including, but not limited to, epoxides, epoxy resins, polyesters, polyester resins, urethanes, polyurethanes, diallyl-phthalates, polyamides, cyanate esters, polycyanurates and combinations thereof.

In other embodiments, a fiber reinforced thermoplastic composite article can include a porous core layer that is free of any bioparticles or biofibers in combination with a skin layer that includes biomaterials, e.g., bioparticles, biofibers or both. An illustration is shown in FIG. 5 where a thermoplastic composite article 500 comprises a skin layer 550 on a surface of porous core layer 505. The porous core layer 505 comprises a web of open celled structures comprising random crossing over of the plurality of reinforcing fibers held together by a thermoplastic material. The core layer 505 is typically porous, e.g., is a porous core layer, with a porosity that can vary from less than 0% up to about 95%. For example, the porous core layer 505 may comprise a void content or porosity of 0-30%, 10-40%, 20-50%, 30-60%, 40-70%, 50-80%, 60-90%, 0-40%, 0-50%, 0-60%, 0-70%, 0-80%, 0-90%, 10-50%, 10-60%, 10-70%, 10-80%, 10-90%, 10-95%, 20-60%, 20-70%, 20-80%, 20-90%, 20-95%, 30-70%, 30-80%, 30-90%, 30-95%, 40-80%, 40-90%, 40-95%, 50-90%, 50-95%, 60-95% 70-80%, 70-90%, 70-95%, 80-90%, 80-95% or any illustrative value within these exemplary ranges.

In certain embodiments, the thermoplastic material of the porous core layer 505 can include polyolefin and/or non-polyolefin materials, which may be virgin thermoplastic materials, recycled thermoplastic materials or both. For example, the thermoplastic material of the core layer 505 comprises one or more of a polyolefin (e.g., one or more of polyethylene, polypropylene, etc.), polystyrene, acrylonitrylstyrene, butadiene, polyethyleneterephthalate, polybutyleneterephthalate, polybutylenetetrachlorate, and polyvinyl chloride, both plasticized and unplasticized, and blends of these materials with each other or other polymeric materials. Other suitable thermoplastics include, but are not limited to, polyarylene ethers, polycarbonates, polyestercarbonates, thermoplastic polyesters, polyimides, polyetherimides, polyamides, co-polyamides, acrylonitrile-butylacrylate-styrene polymers, amorphous nylon, polyarylene ether ketone, polyphenylene sulfide, polyaryl sulfone, polyether sulfone, liquid crystalline polymers, poly(1,4 phenylene) compounds commercially known as PARMAX®, high heat polycarbonate such as Bayer's APEC® PC, high temperature nylon, and silicones, as well as copolymers, alloys and blends of these materials with each other or other polymeric materials. The thermoplastic material used to form the core layer 505 can be used in powder form, resin form, rosin form, particle form, fiber form or other suitable forms. Illustrative thermoplastic materials in various forms are described herein and are also described, for example in U.S. Publication Nos. 20130244528 and US20120065283. The exact amount of thermoplastic material present in the core layer 505 can vary and illustrative amounts range from about 20% by weight to about 80% by weight, e.g., 30-70 percent by weight or 35-65 percent by weight, based on the total weight of the core layer 505. It will be recognized by the skilled person that the weight percentages of all materials used in the core layer 505 will add to 100 weight percent. The thermoplastic material can include only virgin material, only recycled material, or a combination of a virgin material and recycled material. Where a combination of virgin and recycled thermoplastic material are used, The recycled material can be chemically the same or different than the virgin material. Where the recycled material is chemically the same as the virgin material, the recycled material may be physically different than the virgin material, e.g., the recycled material may have a different color, particle size, shape, average glass transition temperature, crystallinity or other physical characteristics that are different than the virgin thermoplastic material even though the virgin thermoplastic material and the recycled thermoplastic material share the same underlying chemistry.

In certain embodiments, the porous core layer 505 can include reinforcing fibers that are non-biofibers, e.g., inorganic fibers, virgin polymeric fibers, etc. As noted herein, the core layer 505 is free of biofibers. For example, the reinforcing fibers in the core layer 505 may comprise glass fibers, carbon fibers, graphite fibers, synthetic organic fibers, particularly high modulus organic fibers such as, for example, para- and meta-aramid fibers, nylon fibers, polyester fibers, natural fibers, a high melt flow index resin (e.g., 100 g/10 min. MFI or above) that is suitable for use as fibers, mineral fibers such as basalt, mineral wool (e.g., rock or slag wool), wollastonite, alumina silica, and the like, or mixtures thereof, metal fibers, metalized natural and/or synthetic fibers, ceramic fibers, yarn fibers, or mixtures thereof. In some configurations, the fibers may comprise reproduced or reclaimed fibers including reproduced polymeric fibers or reproduced glass fibers, e.g., fibers which have been recycled and/or reclaimed with optional physical and/or chemical treatment prior to reuse. In certain embodiments, the fibers used may be cellulose free to avoid or reduce the likelihood of mold or other microbial growth in the core layer 505. In some embodiments, the fibers in the core layer 505 can be bi-component fibers, e.g., core-sheath fibers, as described for example, in U.S. Patent Publication No. 20180162107 published on Jun. 14, 2018. In some embodiments, any of the aforementioned fibers can be chemically treated prior to use to provide desired functional groups or to impart other physical properties to the fibers, e.g., may be chemically treated so that they can react with the thermoplastic material, the biofibers or both. The reinforcing fiber content in the core layer 505 may vary from about 10% to about 90% by weight of the core layer, more particularly from about 20% to about 80%, e.g., about 30% to about 70%, by weight of the core layer 505. The particular size and/or orientation of the fibers used may depend, at least in part, on the thermoplastic material used and/or the desired properties of the core layer 505. For example, the reinforcing fibers can be randomly oriented or may have a specific selected orientation as desired. In one non-limiting illustration, reinforcing fibers dispersed within a thermoplastic material and optionally other additives to provide the core layers can generally have a diameter of greater than about 5 microns, more particularly from about 5 microns to about 22 microns, and a length of from about 5 mm to about 200 mm, more particularly, the fiber diameter may be from about 2 microns to about 22 microns and the fiber length may be from about 5 mm to about 75 mm. Where reinforcing fibers are present in combination with biofibers, the total fiber content in the core layer 105 may vary from about 10% to about 90% by weight of the core layer, more particularly from about 20% to about 80%., e.g., about 30% to about 70%, by weight of the core layer 505.

In some embodiments, other additives or materials may also be present in the core layer 505. For example, antibacterial agents, antifungal agents, antimicrobial agents, a lofting agent, flame retardants, colorants, smoke suppressants, surfactants, foams or other materials may be present. In some examples, the core layer 505 may substantially halogen free or halogen free core layer to meet the restrictions on hazardous substances requirements for certain applications. In other instances, the core layer 505 may comprise a halogenated flame retardant agent such as, for example, a halogenated flame retardant that comprises one of more of F, Cl, Br, I, and At or compounds that including such halogens, e.g., tetrabromo bisphenol-A polycarbonate or monohalo-, dihalo-, trihalo- or tetrahalo-polycarbonates. In some instances, the thermoplastic material used in the core layer 505 may comprise one or more halogens to impart some flame retardancy without the addition of another flame retardant agent. Where halogenated flame retardants are present, the flame retardant is desirably present in a flame retardant amount, which can vary depending on the other components which are present. For example, the halogenated flame retardant may be present in about 0.1 weight percent to about 15 weight percent (based on the weight of the core layer 505), more particularly about 1 weight percent to about 15 weight percent, e.g., about 5 weight percent to about 15 weight percent based on the weight of the core layer 505. If desired, two different halogenated flame retardants may be added to the layers. In other instances, a non-halogenated flame retardant agent such as, for example, a flame retardant agent comprising one or more of N, P. As. Sb, Bi, S, Se, and Te can be added. In some embodiments, the non-halogenated flame retardant may comprise a phosphorated material so the layers may be more environmentally friendly. Where non-halogenated or substantially halogen free flame retardants are present, the flame retardant is desirably present in a flame retardant amount, which can vary depending on the other components which are present. For example, the substantially halogen free flame retardant may be present in about 0.1 weight percent to about 15 weight percent (based on the weight of the layer 505), more particularly about 1 weight percent to about 15 weight percent, e.g., about 5 weight percent to about 15 weight percent based on the weight of the core layer 505. If desired, two different substantially halogen free flame retardants may be added to one or more of the core layers described herein. In certain instances, one or more of the core layers described herein may comprise one or more halogenated flame retardants in combination with one or more substantially halogen free flame retardants. Where two different flame retardants are present, the combination of the two flame retardants may be present in a flame retardant amount, which can vary depending on the other components which are present. For example, the total weight of flame retardants present may be about 0.1 weight percent to about 20 weight percent (based on the weight of the layer 505), more particularly about 1 weight percent to about 15 weight percent, e.g., about 2 weight percent to about 14 weight percent based on the weight of the core layer 505. The flame retardant agents used in the layers described herein can be added to the mixture comprising the thermoplastic material and fibers (prior to disposal of the mixture on a wire screen or other processing component) or can be added after the core layer 505 is formed. In some examples, the flame retardant material may comprise one or more of expandable graphite materials, magnesium hydroxide (MDH) and aluminum hydroxide (ATH).

In some embodiments, a lofting capacity of the core layer 505 can be tuned by including one or more added lofting agents in the core layer 505. The exact type of lofting agent used in the core layer 505 can depend on numerous factors including, for example, the desired lofting temperature, the desired degree of loft, etc. In some instances, microsphere lofting agents, e.g., expandable microspheres, which can increase their size upon exposure to convection heating may be used. Illustrative commercially available lofting agents are available, for example, from Kurcha Corp. (Japan). In other examples, the lofting agent in the core layer 505 may be an expandable graphite material or a combination of a microsphere lofting agent with a non-microsphere lofting agent.

In certain configurations, the skin layer 550 on the core layer 505 can include a plurality of biofibers. The biofibers in the skin layer 505 can include one or more biomaterials which have been sized and arranged as fibers. The biofibers can provide reinforcement to the skin layer 550. In certain embodiments, the biofibers in the skin layer 550 can include one or more of biofibers produced from plant byproducts, animal byproducts or combinations thereof. For example, the biofibers in the skin layer 550 can be produced from one or more of rice hulls, coconuts shells, coffee chaff, wheat hulls, corn hulls, wood particles, coffee bean grounds, plant byproducts and combinations thereof. In other embodiments, the biofibers in the skin layer 550 can be produced from egg shells, animal hair, animal bone, animal fat, animal meat, animal collagen, or other animal products and byproducts and combinations thereof. The exact amount of bioparticles or biofibers in the skin layer 550 may vary from about 5% by weight to about 90% by weight, more particularly about 5% by weight to about 80% by weight of the skin layer, e.g., about 5-20% by weight, 5-30% by weight, 5-40% by weight, 5-50% by weight, 5-60% by weight, 10-60% by weight, 10-50% by weight, 20-50% by weight, 20-40% by weight or about 20 weight percent to about 80 weight percent or other amounts. If desired, both bioparticles and biofibers can be present in the skin layer 550.

In certain embodiments, the skin layer 550 comprising the biomaterials may comprise one or more of a film (e.g., thermoplastic film or elastomeric film), a frim, a scrim (e.g., fiber based scrim), a foil, a woven fabric, a non-woven fabric or be present as an inorganic coating, an organic coating, or a thermoset coating disposed on the core layer 505. In some examples, the skin layer 550 may also comprise natural fibers, polymeric fibers, or other materials as described herein. In other instances, the skin layer 550 may comprise a limiting oxygen index greater than about 22, as measured per ISO 4589 dated 1996. Where a thermoplastic film is present as part of the skin layer 550, the thermoplastic film may comprise at least one of poly(ether imide), poly(ether ketone), poly(ether-ether ketone), poly(phenylene sulfide), poly(arylene sulfone), poly(ether sulfone), poly(amide-imide), poly(1,4-phenylene), polycarbonate, nylon, a polyolefin (e.g., polyethylene, polypropylene, etc.) and silicone. Where a fiber based scrim is present as (or as part of) the skin layer 550, the fiber based scrim may comprise at least one of glass fibers, aramid fibers, graphite fibers, carbon fibers, inorganic mineral fibers, metal fibers, metalized synthetic fibers, and metalized inorganic fibers. Where a thermoset coating is present as part of the skin layer 550, the coating may comprise at least one of unsaturated polyurethanes, vinyl esters, phenolics and epoxies. Where an inorganic coating is present as part of the skin layer 550, the inorganic coating may comprise minerals containing cations selected from Ca, Mg. Ba, Si, Zn, Ti and Al or may comprise at least one of gypsum, calcium carbonate and mortar. Where a non-woven fabric is present as (or as part of) the skin layer 550, the non-woven fabric may comprise a thermoplastic material, a thermal setting binder, inorganic fibers, metal fibers, metallized inorganic fibers and metallized synthetic fibers.

In certain configurations, an optional adhesive layer (not shown) may be present between the skin layer 550 and the core layer 505. In instances where an adhesive is desirable, one or more thermoplastic polymer adhesives may be used. For example, it may be desirable to couple the skin layer 550 to the core layer 505 using an adhesive. In some examples, the thermoplastic component of the adhesive layer may comprise a thermoplastic polymer (which can be virgin or recycled) such as, for example, a polyolefin such as a polyethylene or a polypropylene. In other instances, the thermoplastic polymer of the adhesive layer may comprise, polystyrene, acrylonitrylstyrene, butadiene, polyethyleneterephthalate, polybutyleneterephthalate, polybutylenetetrachlorate, and polyvinyl chloride, both plasticized and unplasticized, and blends of these materials with each other or other polymeric materials. Other suitable thermoplastic polymers for use in the adhesive layer include, but are not limited to, polyarylene ethers, polycarbonates, polyestercarbonates, thermoplastic polyesters, polyimides, polyetherimides, polyamides, acrylonitrile-butylacrylate-styrene polymers, amorphous nylon, polyarylene ether ketone, polyphenylene sulfide, polyaryl sulfone, polyether sulfone, liquid crystalline polymers, poly(1,4 phenylene) compounds commercially known as PARMAX®, high heat polycarbonate such as Bayer's APEC® PC, high temperature nylon, and silicones, as well as alloys and blends of these materials with each other or other polymeric materials. If desired, the adhesive may also comprise some thermosetting material including, but not limited to, epoxides, epoxy resins, polyesters, polyester resins, urethanes, polyurethanes, diallyl-phthalates, polyamides, cyanate esters, polycyanurates and combinations thereof.

In certain embodiments, the core layer 505 and skin layer 550 comprising the biomaterials can be used in combination with a skin layer 320 to provide a composite article 600 as shown in FIG. 6. The skin layer 320 in FIG. 6 may comprise any of those materials described herein in reference to the skin layer 320 shown in FIG. 3. Further, an optional adhesive layer can be present between the skin layer 320 and the core layer 505 if desired. The adhesive layer can include any of those materials noted herein in connection with the optional adhesive layer between the skin layer 550 and the core layer 505.

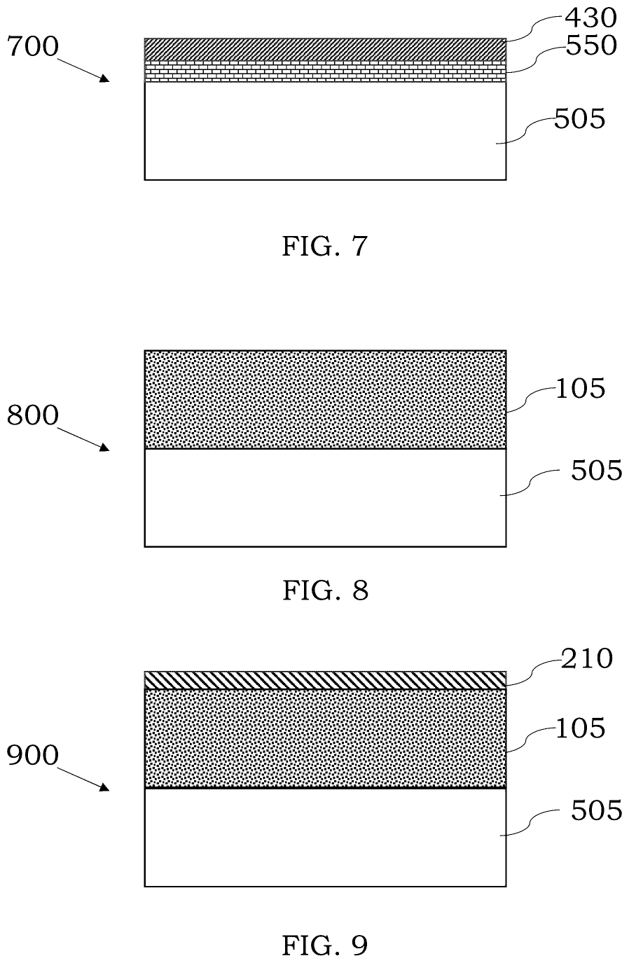

In other embodiments, the core layer 505 and the skin layer 550 comprising the biomaterials can be used in combination with a decorative layer 430 to provide a composite article 700 as shown in FIG. 7. The decorative layer 430 in FIG. 7 may comprise any of those materials described herein in reference to the decorative layer 430 shown in FIG. 4. Further, an optional adhesive layer can be present between the decorative layer 430 and the skin layer 550 if desired. The adhesive layer can include any of those materials noted herein in connection with the optional adhesive layer between the skin layer 550 and the core layer 505.

In certain configurations, a porous core layer with biomaterials can be coupled to a porous core layer without any biomaterials. An illustration is shown in FIG. 8, where a thermoplastic composite article 800 comprises a porous core layer 105 comprising biomaterials and a porous core layer 505 without any biomaterials. The porous core layers 105, 505 can include any of those materials described herein in reference to FIGS. 1 and 5, respectively. If desired, an optional adhesive layer can be used to couple the porous core layer 105 to the porous core layer 505. For example, where an adhesive is used, one or more thermoplastic polymer adhesives may be used. For example, it may be desirable to couple the core layer 105 to the core layer 505 using an adhesive. In some examples, the thermoplastic component of the adhesive layer may comprise a thermoplastic polymer such as, for example, a polyolefin such as a polyethylene or a polypropylene. In other instances, the thermoplastic polymer of the adhesive layer may comprise, polystyrene, acrylonitrylstyrene, butadiene, polyethyleneterephthalate, polybutyleneterephthalate, polybutylenetetrachlorate, and polyvinyl chloride, both plasticized and unplasticized, and blends of these materials with each other or other polymeric materials. Other suitable thermoplastic polymers for use in the adhesive layer include, but are not limited to, polyarylene ethers, polycarbonates, polyestercarbonates, thermoplastic polyesters, polyimides, polyetherimides, polyamides, acrylonitrile-butylacrylate-styrene polymers, amorphous nylon, polyarylene ether ketone, polyphenylene sulfide, polyaryl sulfone, polyether sulfone, liquid crystalline polymers, poly(1,4 phenylene) compounds commercially known as PARMAX®, high heat polycarbonate such as Bayer's APEC® PC, high temperature nylon, and silicones, as well as alloys and blends of these materials with each other or other polymeric materials. If desired, the adhesive may also comprise some thermosetting material including, but not limited to, epoxides, epoxy resins, polyesters, polyester resins, urethanes, polyurethanes, diallyl-phthalates, polyamides, cyanate esters, polycyanurates and combinations thereof.

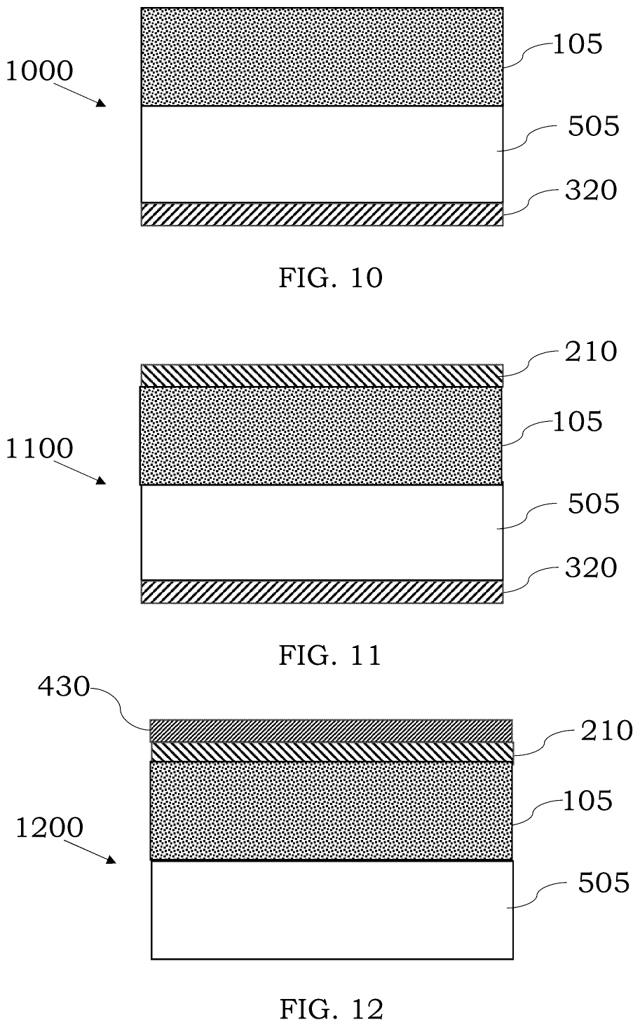

In certain configurations, the coupled core layers 105, 505 can be used in combination with a skin layer 210 (FIG. 9) to provide a thermoplastic composite article 900. The coupled core layers 105, 505 can be used in combination with a skin layer 320 (FIG. 10) to provide a thermoplastic composite article 1000. Skin layers 210, 320 may both be present to provide a composite article 1100 as shown in FIG. 11. In other instances, the coupled core layer 105, 505 can be used with a decorative layer 430 to provide a composite article 1200 as shown in FIG. 12. Another skin (not shown) could be disposed on a surface of the core layer 505 in FIG. 12.

While the core layers 105, 505 are different in FIGS. 8-12, if desired, two or more core layers of the same type could be coupled. For example, two core layers each of which has the composition of the core layer 105 could be coupled. Alternatively, two core layers each of which has the composition of the core layer 505 could be coupled.

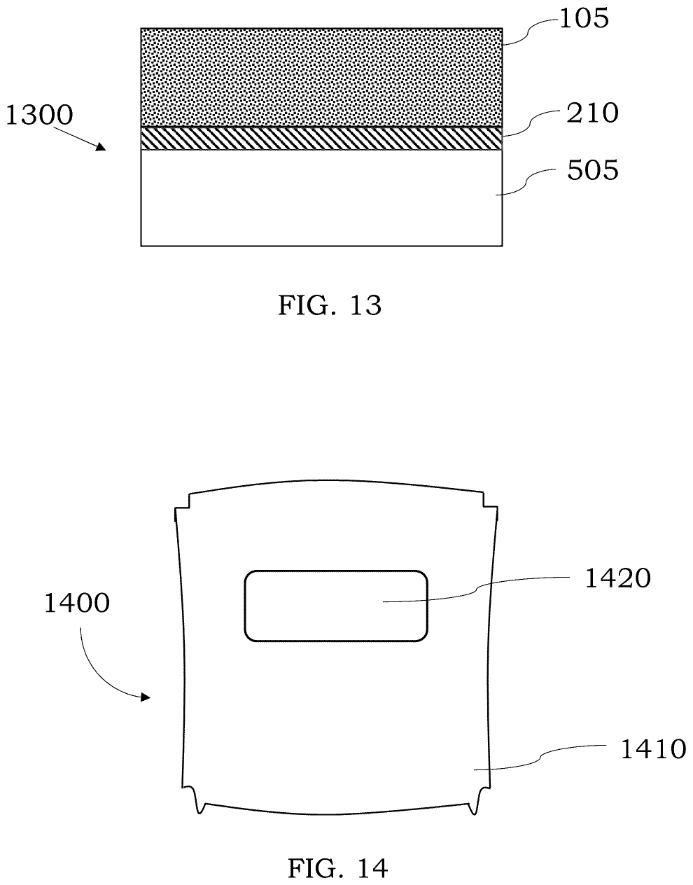

In certain embodiments, a skin layer may be present between two different core layers. Referring to FIG. 13, a composite article 1300 is shown that comprises a skin layer 210 present between a core layer 105 and a core layer 505. An optional adhesive layer can be present between any two of the components as noted herein. Alternatively, the skin layer 210 itself may function to couple the core layer 105 to the core layer 505.

In certain embodiments, where multiple core layers are used together, one or more of the core layers can include recycled thermoplastic materials as noted herein. If desired, each core layer can include recycled thermoplastic materials. In some embodiments, one of the core layers can include recycled thermoplastic materials in combination with biomaterials, and the other core layer can include virgin thermoplastic material in combination with biomaterials or non-biomaterials or both. In another embodiment, one of the core layers can include recycled thermoplastic materials in combination with non-biomaterials, and the other core layer can include virgin thermoplastic material in combination with biomaterials or non-biomaterials or both. Other variations where at least one core layer includes one or more of recycled thermoplastic materials, biomaterials, and/or non-biomaterials are also possible.

In certain embodiments, any one or more of the core layers described herein may be configured as (or used in) a glass mat thermoplastic composite (GMT) or a light weight reinforced thermoplastic (LWRT). The areal density of such a GMT or LWRT can range from about 200 grams per square meter (gsm) of the GMT or LWRT to about 4000 gsm, although the areal density may be less than 200 gsm or greater than 4000 gsm depending on the specific application needs. In some embodiments, the upper density can be less than 4000 gsm.

In certain examples, one or more of the core layers described herein can be generally prepared using chopped fibers (reinforcing fibers or biofibers or both), a thermoplastic material (virgin, recycled or both), optionally a lofting agent and/or other materials. For example, a thermoplastic material (virgin, recycled or both) and any fibers can be added or metered into a dispersing foam contained in an open top mixing tank fitted with an impeller. If desired, separate tanks can be used for virgin thermoplastic materials and recycled thermoplastic materials to permit adjustment of the exact amounts of each material in the final article. Without wishing to be bound by any particular theory, the presence of trapped pockets of air of the foam can assist in dispersing the fibers and the thermoplastic material. In some examples, the dispersed mixture of fibers and thermoplastic material can be pumped to a head-box located above a wire section of a paper machine via a distribution manifold. The foam, not the fibers and thermoplastic, can then be removed as the dispersed mixture is provided to a moving wire screen using a vacuum, continuously producing a uniform, fibrous wet web comprising the fibers and the thermoplastic material. The wet web can be passed through a dryer at a suitable temperature to reduce moisture content and to melt or soften the thermoplastic material. The skin layers, decorative layers, etc. can then be applied to the web optionally using an adhesive material between the web and the other layers. The assembly can be passed through one or more sets of rollers to pressure the skins into the web and/or compress the assembly to a desired thickness. The resulting thermoplastic composite article can be cut, sized or otherwise subjected to post-production steps as desired. The machine direction of the process generally refers to the direction of the moving wire screen, whereas the cross direction refers to a direction orthogonal to the machine direction. As noted herein, if desired, the reinforcing fibers, biofibers or both can be randomly oriented or oriented at a specific angle with respect to the machine direction. It may be desirable to orient biofibers in a skin layer to have an angle of orientation of 30 degrees, 45 degrees, 60 degrees, 75 degrees or 90 degrees relative to the machine direction.

In certain configurations, the fiber reinforced thermoplastic composite articles described herein can be produced by adding a plurality of reinforcing fibers, a plurality of biomaterials, e.g., a plurality of bioparticles and/or a plurality of biofibers, and a thermoplastic material (virgin, recycled or both) to an agitated aqueous foam to form a dispersed mixture. The dispersed mixture of the plurality of reinforcing fibers, the biofibers and the thermoplastic material can be deposited onto a forming support element, e.g., a moving wire screen or other element. Liquid can be evacuated from the deposited, dispersed mixture to form a web. The web, for example, may comprise the fibers which are held in place by the thermoplastic material. The web can be heated above a softening temperature of the thermoplastic material. This softening temperature can vary depending on the nature of the different thermoplastic materials that may be present. The heated web can be compresses to a selected or predetermined thickness, e.g., 500 microns to about 20 mm, more particularly about 1 mm to about 10 mm or about 2 mm to about 8 mm.

A skin layer can be disposed on the compressed web to provide the thermoplastic composite article. Alternatively, a skin layer can be disposed on the web prior to compression and the resulting thermoplastic composite article can be compressed to a desired overall thickness. As noted herein, the skin layer may or may not include biofibers or bioparticles as desired.

In certain embodiments, the core layers, skin layers and/or the thermoplastic composite articles described herein can be used to produce interior components or parts. For example, the thermoplastic composite article may be present in a vehicular interior panel, an interior automotive part, an automotive headliner, a recreational interior panel, a recreational vehicle interior part, an interior building material or other articles.

In certain configurations, the core layers, skin layers and/or thermoplastic composite articles described herein can be used to provide a vehicle headliner. Illustrative vehicles include, but are not limited to, automotive vehicles, trucks, trains, subways, recreational vehicles, aircraft, ships, submarines, space craft and other vehicles which can transport humans or cargo. In some instances, the headliner typically comprises at least one core layer as described herein and a decorative layer, e.g., a decorative fabric, disposed on the core layer. The decorative layer, in addition to being aesthetically and/or visually pleasing, can also enhance sound absorption and may optionally include foam, insulation or other materials. An illustration of a top view of a headliner is shown in FIG. 14. The headliner 1400 comprises a body 1410 and an opening 1420, e.g., for a sunroof, moonroof, etc., though more than a single opening may be present if desired. The body of the headliner 1410 can include one or more of the thermoplastic composite articles described herein optionally with decorative layers, fabrics, cloth, etc. The opening 1420 is optional and can be produced by trimming the headliner 1400. The “C” surface or roof side of the headliner typically consists of a non-woven scrim layer for handling purposes. The overall shape and geometry of the headliner 1400 may be selected based on the area of the vehicle which the headliner is to be coupled. For example, the length of the headliner can be sized and arranged so it spans from the front windshield to the rear windshield, and the width of the headliner can be sized and arranged so it spans from the left side of the vehicle to the right side of the vehicle.

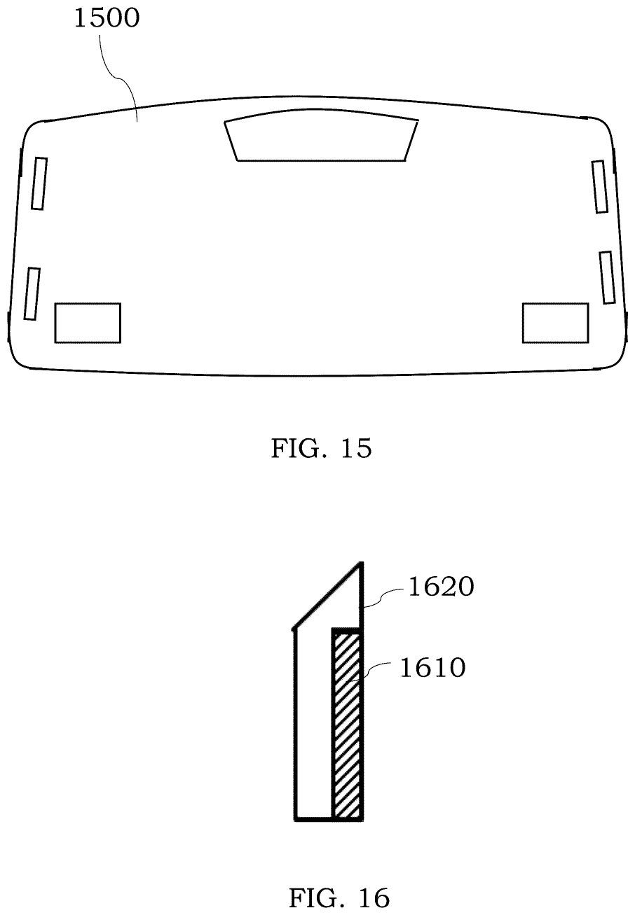

In certain instances, the core layers, skin layers and/or the thermoplastic composite articles described herein can be used to produce interior automotive trim pieces or parts. An illustration of top view of a rear window trim 1500 is shown in FIG. 15. The particular outer layers used in the rear window trim 1500 may be different from the headliner. For example, the rear window trim may comprise a scrim or other outer layer to increase its durability and/or the acoustic characteristics. While various openings are shown in the rear window trim 1500, the positions and geometries of these openings may vary. In addition, typical rear window trim decorative material may comprise a non-backed PET or PP carpet. The window trim 1500 may comprise one or more of the core layers and/or thermoplastic composite articles described herein.

In some examples, the core layers, skin layers and/or thermoplastic composite articles described herein can be used as interior trim applications, e.g., RV interior trim, interior trim for building or for automotive applications. The interior trim can be coupled to other materials, such as, for example, wood, PVC, vinyl, plastic, leather or other materials. A side view illustration of a trim piece that can be used as baseboard trim is shown in FIG. 16. The trim piece comprises a trim substrate 1620. The trim piece may be nailed, glued or otherwise attached to a stud or wallboard 1610 as desired. The trim piece 1620 faces outward and is viewable within a room. The trim piece 1620 can be curved or may take two or three dimensional shapes as desired. If desired, one or more decorative skins may be present on an outside of the trim piece and facing into the interior of the room.

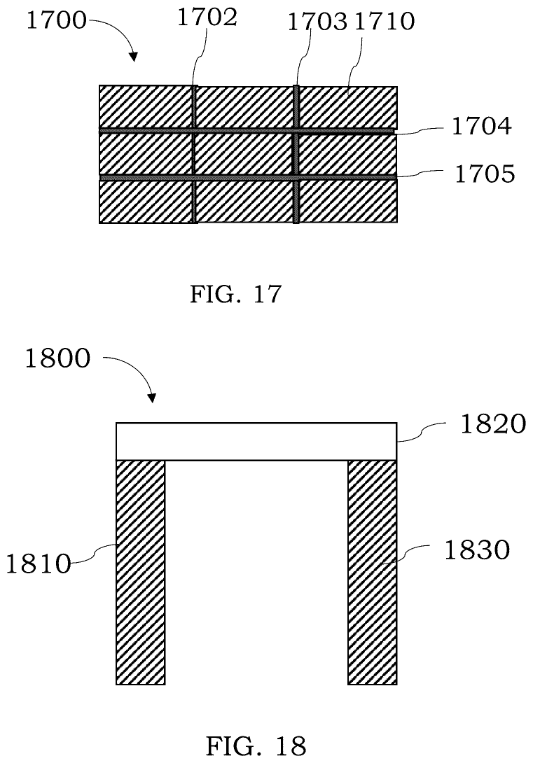

In certain examples, the core layers, skin layers and/or thermoplastic composite articles described herein can be used in composite articles configured for interior use in recreational vehicle panels, wall panels, building panels, roofs, flooring or other applications. As noted herein, the composite articles can be used in an as-produced state or can be molded. In certain examples, the articles described herein can be configured as a ceiling tile. Referring to FIG. 17, a grid of ceiling tiles 1700 is shown that comprises support structures 1702, 1703, 1704 and 1705 with a plurality of ceiling tiles, such as tile 1710, laid into the grid formed by the support structures. In some examples, the ceiling tile comprises one or more of the core layers, skin layers and/or the thermoplastic composite articles described herein. In some examples, the ceiling tile 1710 may comprise a porous decorative layer, e.g., a fabric, cloth, or other layers, disposed on a porous core layer or a skin layer as described herein.

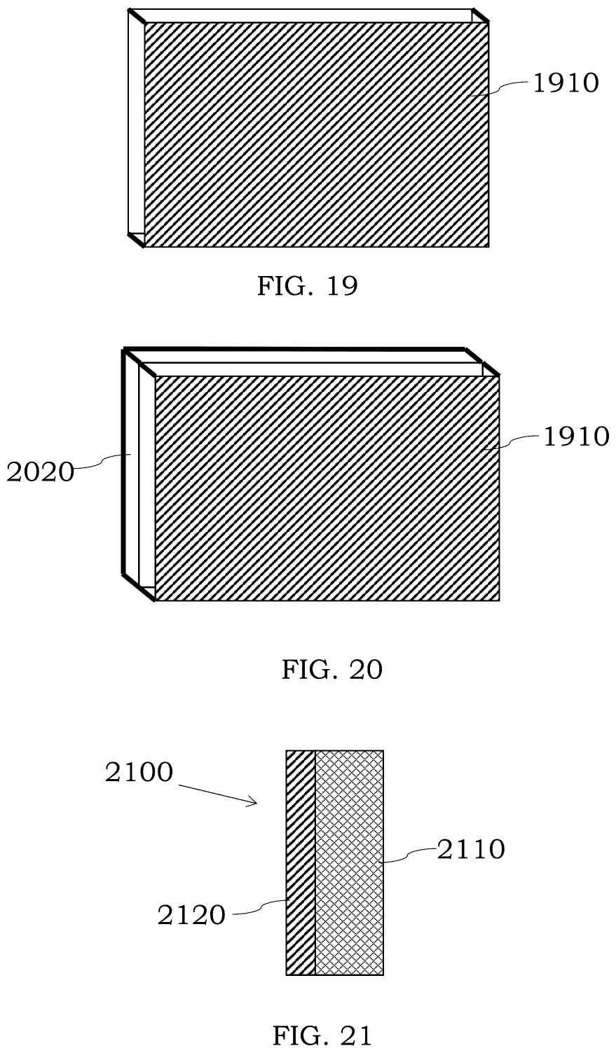

In certain examples, a cubicle panel may comprise one or more of the core layers, skin layers and/or thermoplastic composite articles. Referring to FIG. 18, a top view of a cubicle 1800 comprising side panels 1810, 1830 and center panel 1820 are shown. Any one or more of the panels 1810-1830 may comprise one of the core layers, skin layers and/or thermoplastic composite articles described herein. The cubicle panel may also comprise one or more skin layers. In some examples, the cubicle wall panel is sized and arranged to couple to another cubicle wall panel.

In certain embodiments, the core layers, skin layers and/or thermoplastic composite articles described herein can be present in a structural panel. The structural panel can be used, for example, as sub-flooring, wall sheathing, roof sheathing, as structural support for cabinets, countertops and the like, as stair treads, as a replacement for plywood and other applications. If desired, the structural panel can be coupled to another substrate such as, for example, plywood, oriented strand board or other building panels commonly used in residential and commercial settings. Referring to FIG. 19, a top view of a structural panel 1910 is shown. The panel 1910 may comprise any one or more of the core layers, skin layers and/or thermoplastic composite articles described herein. If desired, two or more structural panels can be sandwiched with a skin facing into the interior of the room and another skin of the other structural panel facing outward away from the interior of the room. In some instances, the structural panel may also comprise a structural substrate 2020 as shown in FIG. 20. The exact nature of the structural substrate 2020 may vary and includes, but is not limited to, plywood, gypsum board, wood planks, wood tiles, cement board, oriented strand board, polymeric or vinyl or plastic panels and the like. In some examples, the structural substrate comprises a plywood panel, a gypsum board, a wood tile, a ceramic tile, a metal tile, a wood panel, a concrete panel, a concrete board or a brick. If desired, the structural panel may further comprise a second structural panel coupled to a skin layer of the first structural panel.

In certain instances, the core layers, skin layers and/or thermoplastic composite articles described herein can be present in a wall board or wall panel. The wall panel can be used, for example, to cover studs or structural members in a building, to cover ceiling joists or trusses and the like. If desired, the wall panel can be coupled to another substrate such as, for example, tile, wood paneling, gypsum, concrete backer board, or other wall panel substrates commonly used in residential and commercial settings. Referring to FIG. 21, a side view of a wall panel 2100 is shown. The panel 2100 may comprise one or more of the core layers, skin layers and/or thermoplastic composite articles described herein. For example, the wall panel 210 may also comprise at least one skin 2120 coupled to a first surface of a porous core layer 2110. While not shown, a second skin may be placed on a second surface of the core layer 2110. An optional wall substrate can be coupled to a second surface of the porous core layer 2110 and configured to support the porous core layer 2110 when the wall panel 2100 is coupled to a wall surface. In certain configurations, the wall panel 2100 further comprises a porous decorative layer disposed on the skin 2120. In certain embodiments, a second wall panel can be coupled to the skin 2120.

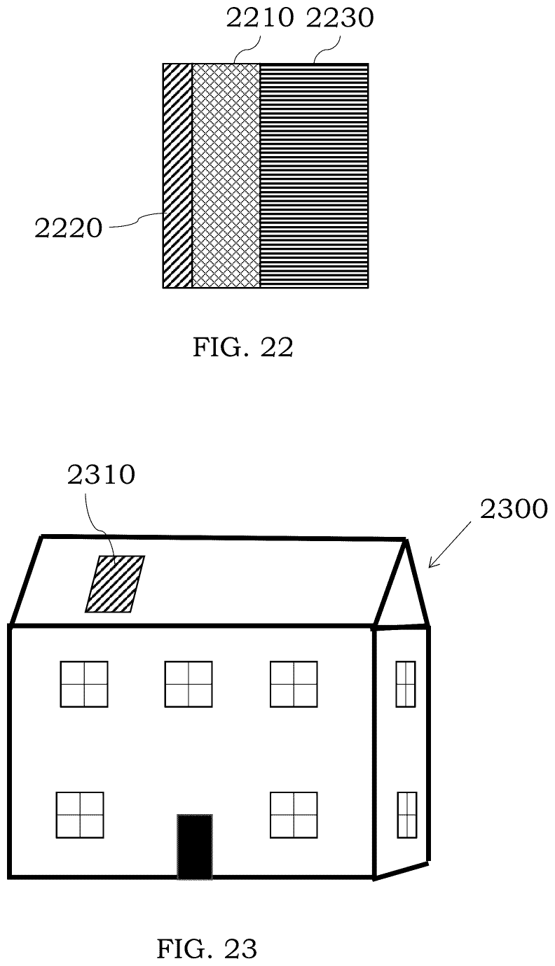

In certain instances, the core layers, skin layers and/or thermoplastic composite articles described herein can be present in a siding panel to be attached to a building such as a residential home or a commercial building. The siding panel can be used, for example, to cover house wrap, sheathing or other materials commonly used on outer surfaces of a building. If desired, the siding panel can be coupled to another substrate such as, for example, vinyl, concrete boards, wood siding, bricks or other substrates commonly placed on the outside of buildings. Referring to FIG. 22 a side view of a siding panel is shown. The panel may comprise any one or more of the core layers, skin layers and/or thermoplastic composite articles described herein, e.g., a core layer 2210 and a skin 2220. A building substrate 2230 can be configured with many different materials including, but not limited to vinyl, wood, brick, concrete, etc. For example, a vinyl substrate can be coupled to a first surface of the skin 2220, and the siding can be configured to couple to a non-horizontal surface of a building to retain the siding panel to the non-horizontal surface of the building. In some instances, the siding panel further comprises a weather barrier, e.g., house wrap, a membrane, etc. coupled to a second surface of the flame retardant and noise reducing layer. In some embodiments, the substrate comprises a nailing flange to permit coupling of the siding to the side of the building. In some examples, the siding panel may further comprise a second siding panel and can be coupled to a second substrate. In some cases, a butt joint, overlapping joint, etc. may exist where the two siding panels can horizontally lock into each other.

In certain instances, the core layers, skin layers and/or thermoplastic composite articles described herein can be present in a roofing panel to be attached to a building such as a residential home or a commercial building. The roofing panel can be used, for example, to cover an attic space, attach to roof trusses or cover a flat roof as commonly present in commercial buildings. If desired, the roofing panel can be coupled to another substrate such as, for example, oriented strand board, plywood, or even solar cells that attach to a roof and function to cover the roof. Referring to FIG. 23, a perspective view of a roofing panel 2310 attached to a house 2300 is shown. The roofing panel 2310 may comprise any one or more of the core layers, skin layers and/or thermoplastic composite articles described herein. If desired, two or more roofing panels can be sandwiched or otherwise used together. The roofing panel may also comprise a roofing substrate coupled to a first surface of a core layer and can be coupled to a roof of a building to retain the roofing panel to the roof. In some examples, the roofing panel may comprise, or be used with, a weather barrier, e.g., a membrane, house wrap, tar paper, plastic film, etc. In certain instances, the roofing panel comprises a second roofing panel or can be overlapped with, or coupled to, a second roofing panel to prevent moisture from entering into the house 2300.

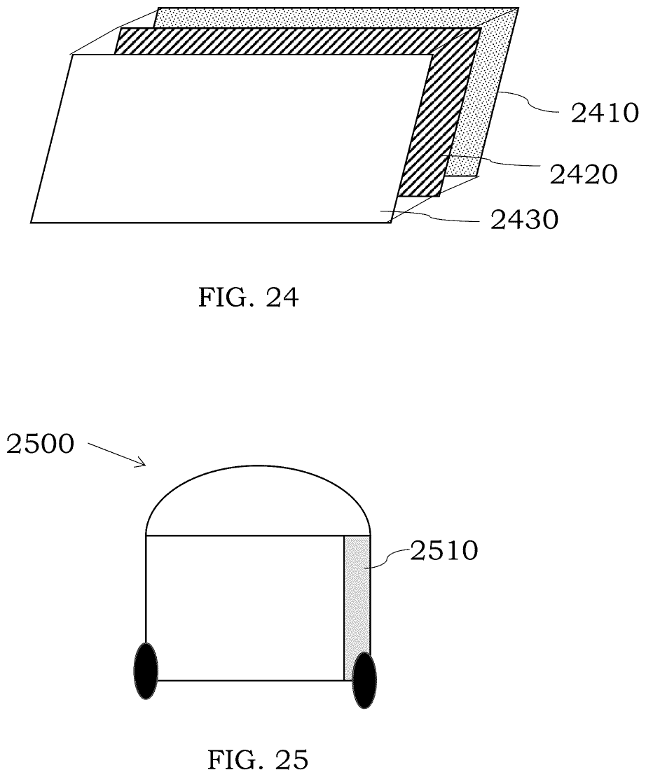

In certain configurations, the core layers, skin layers and/or thermoplastic composite articles described herein can be present in a roofing shingle to be attached to a building such as a residential home or a commercial building to absorb sound and to provide flame retardancy. The roofing shingle can be used, for example, to cover a roof commonly present in residential and commercial buildings. If desired, the roofing shingle can be coupled to another substrate such as, for example, asphalt, ceramic, clay tile, aluminum, copper, wood such as cedar and other materials commonly found or used as roofing shingles Referring to FIG. 24, an exploded view of a roofing shingle is shown. The roofing shingle 2400 may comprise any one or more of the core layers, skin layers and/or thermoplastic composite articles described herein. If desired, two or more roofing shingles can be sandwiched. In some examples, the roofing shingle may comprise a core layer 2410. If desired, a weatherproof roofing shingle substrate 2430 can be coupled to a first surface and configured to couple to a roofing panel of a building to provide a weatherproof and flame retardant roofing panel. In certain instances, a weather barrier can be coupled to a roofing shingle. In other examples, the roofing shingle comprises asphalt. An intermediate layer 2420, e.g., a skin, insulation or other materials, can be present between the outer layer 2430 and core layer 2410.

In certain configurations, any one or more of the core layers, skin layers and/or thermoplastic composite articles described herein can be present in an interior panel or wall of a recreational vehicle (RV) or an interior panel of an aircraft or aerospace vehicle, e.g., a rocket, satellite, shuttle or other airline or space vehicles. The panel or wall can be used, for example, to cover a skeleton structure on an interior side of the recreational or aerospace vehicle and may be coupled to foam or other insulation materials between the interior and exterior of the vehicle. In some examples, the core layers, skin layers and/or thermoplastic composite articles described herein may be part of a sandwich structure formed from the core layer or article and other layers. If desired, the interior panel can be coupled to another substrate such as, for example, a fabric, plastic, tile, etc.

Referring to FIG. 25, a side view of a recreational vehicle 2500 is shown. The interior panel 2510 may comprise any one or more of the core layers, skin layers and/or thermoplastic composite articles described herein. If desired, two or more RV panels can be sandwiched or coupled together. In some examples, an RV panel may comprise an interior wall substrate that is configured as a decorative layer such as a fabric, a plastic, tile, metal, wood or the like. In additional instances, the RV panel comprises a second RV interior panel which can be the same or different from the RV panel. If desired, the RV panel may comprise a third RV interior panel which may also be the same or different. While not shown, a similar interior panel can be present in aerospace applications/vehicles and may be placed against and/or coupled to an exterior skin such as a metal or metal alloy skin or structure, e.g., aluminum, magnesium, titanium, etc. or other exterior structure.

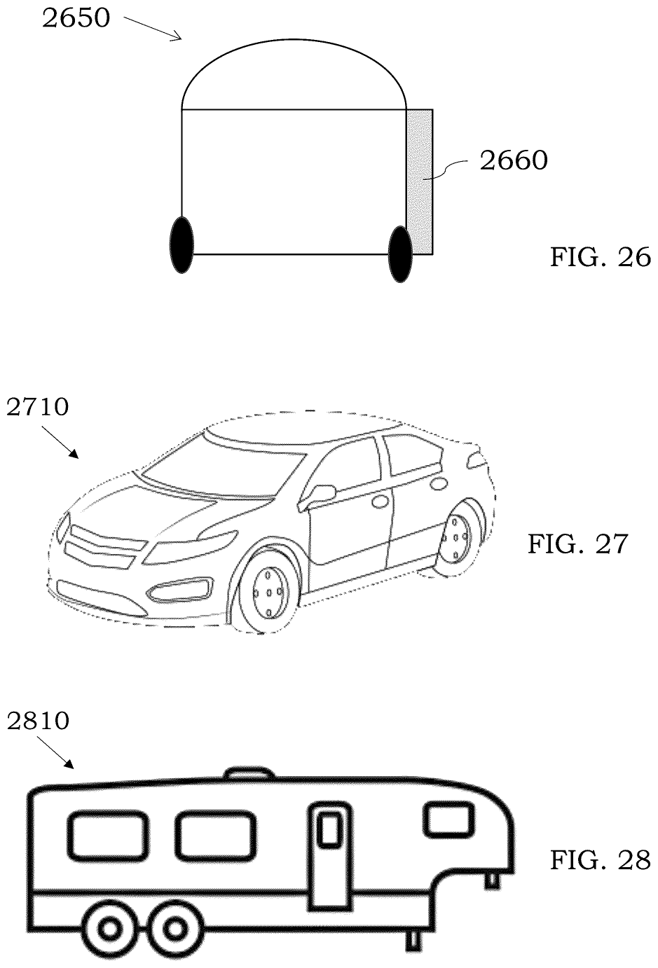

In certain configurations, any one or more of the core layers, skin layers and/or thermoplastic composite articles described herein can be configured as, or present in, an exterior panel or wall of an aircraft vehicle, an aerospace vehicle or a recreational vehicle. The panel or wall can be used, for example, to cover a skeleton structure on an exterior side of the vehicle and may be coupled to foam or other insulation materials between the interior and exterior of the vehicle. In some examples, the core layer or article may be part of a sandwich structure formed from the core layer or article and other layers. If desired, the exterior panel can be coupled to another substrate such as, for example, a metal, a metal alloy, fiberglass, etc. Referring to FIG. 26, a side view of a recreational vehicle 2650 is shown that comprises an exterior panel 2660, which can be configured as any one of the core layers, skin layers and/or thermoplastic composite articles described herein. If desired, two or more RV panels can be sandwiched with a skin facing into the interior of the RV and a skin of the other RV panel facing outward away from the interior of the RV. In certain configurations, the exterior wall substrate comprises glass fibers or is configured as a metal panel such as aluminum or other metal materials. In additional instances, the RV panel comprises a second RV exterior panel which can be the same or different from the RV panel. If desired, the RV panel may comprise a third RV exterior panel which may also be the same or different. While not shown, a similar exterior panel can be present in aerospace applications/vehicles and may be placed against and/or coupled to an interior skin or structure such as an interior metal or metal alloy skin, e.g., aluminum, magnesium, titanium, etc., or other interior structure.

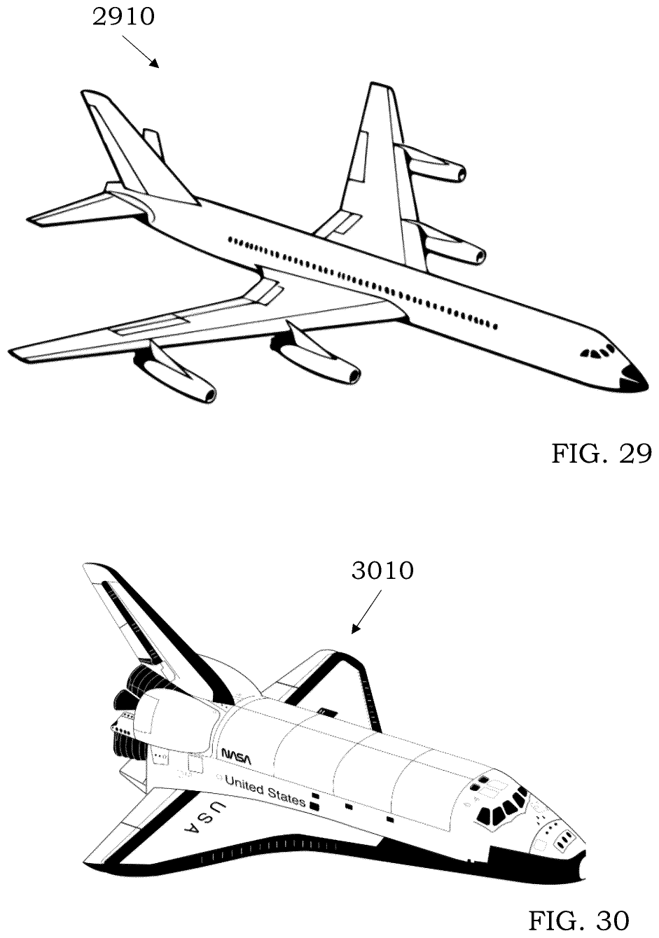

In certain examples, the core layers, skin layers and/or thermoplastic composite articles described herein can be used in an automotive vehicle 2710 (FIG. 27), a recreational vehicle 2810 (FIG. 28), an airplane 2910 (FIG. 29), a shuttle or a spacecraft 310 (FIG. 30), a rocket, a satellite, or other vehicles which comprise one or more wheels, an engine, a motor, a turbine, a rocket, a fuel cell, a battery, are solar powered, are powered by wind, are gas propelled or have a motive means which can be used to propel the vehicle. As shown in FIG. 28, however, vehicles with the core layers, skin layers and/or thermoplastic composite articles described herein may be towed behind or coupled to another vehicle if desired and may not have an independent motor or engine to propel them. Where biomaterials are present in the vehicle, the biomaterials can be present on parts or components used internally or external parts or components. If desired, exterior parts or components can include a biocidal agent to reduce growth of mold, bacteria, fungus, etc. or otherwise reduce the likelihood of rot.

Certain specific examples are described to facilitate a better understanding of the technology described herein.

### Example 1

The natural fibers (rice hulls (RH) or Kenaf Fibers (KF) included biocomposite and the standard glass fiber only LWRT (S-LWRT) core panel were manufactured using a continuous wet-laid thermoforming process involving 1) mixing the polypropylene (PP) resin powder, glass fiber, and biomaterials (rice hull ground or chopped kenaf fiber) in a tank and forming the resin/fiber slurry in water with foaming agent, 2) wet-laying the resin/fiber mixture onto a former belt, 3) drying wet mat and melting the resin in oven, 4) laminating surface skin materials (scrim and film) and consolidating the mat/skin assembly to flat sheet, and 5) cutting the formed sheet into desired length. Either 10% or 20% of the RHs or KF were incorporated in the biocomposite. The areal density target of all formulations was 1000 g/m² (gsm). The formulation of all materials and their codes are shown in Table 1.

TABLE 1

| | Natural | Natural | Core areal | |
|---|---|---|---|---|
| Sample | fiber | fiber (%) | density (gsm) | Skins |
| RH10 | Rice hull | 10 | 1000 | 20 gsm scrim on one |
| RH20 | Rice hull | 20 | | side and 98 gsm |
| KF10 | Kenaf | 10 | | film on the other |
| KF20 | Kenaf | 20 | | side |
| S- | None | 0 | | |
| LWRT | | | | |

The as-produced flat sheets were cut into small plaques (483 mm×483 mm) and molded to flat panels with thickness target of 2.75 mm in a thermoformer. The molded flat panels were tested for physical and mechanical properties. The physical and analytical tests were conducted on disks with 99 mm diameter according to an internal standard procedure. The areal density (gsm), ash content (%), density (g/cm³), and as-produced thickness (mm) of the samples were measured, with 10 replicates for each property. The resistance to compression of the heated panels was tested following an internal testing procedure. Specimens (102 mm×432 mm) were heated in IR oven. When being heated above the melting temperature of the resin the flat sheets experience expansion in thickness direction resulting to thickness increase, which is called lofting. Heated and lofted samples were carefully placed under the weights (0.25, 0.5, 1, 2, 4, and 8 pounds) in the fixture and gently lower the weight on the hot material. The thickness (mm) of the non-compressed section was measured to assess the resistance to compression of the lofted material. A higher thickness in the non-compressed section indicates greater resistance to compression. The flammability performance was evaluated following the Federal Motor Vehicle Safety Standards (FMVSS 302-03). FMVSS 302 is more commonly accepted in automotive interior applications. Molded samples were cut into 305 mm×25 mm and tested horizontally with the film side of sample facing to flame. Flexural (3-point bending) test was performed on molded samples on an MTS mechanical tester following the ISO 178 method (dated 2011). Ten rectangular (100 mm×10 mm) specimens were cut from the molded plaques in the machine direction (MD) and cross-machine direction (CD). The test was performed using a 250 N load cell with scrim side facing against load. The cross-head speed, span, anvil diameter, and nose diameter was 15 mm/min, 64 mm, 4.0 mm and 10 mm, respectively. Tensile test of the molded samples was performed on a MTS mechanical testing machine according to ISO 527 (as revised on 2001). Ten specimens (150 mm×10 mm) were cut out along MD and CD and tested. Cross head speed was 5 mm/min and the load cell was 5 kN.

In order to assess the formability of the biocomposite sheets, the internally developed torture tool molds were used. Torture molds are specifically designed to evaluate the sheet materials' ability to undergo significant shape changes, representative of critical deformations encountered in the production of manufactured parts. This allowed for an evaluation of whether the sheet materials could successfully conform to the desired shapes for trunk trim, door panel or other applications requiring deep-drawing processes. Wedge and cupcake shapes were studied in this work. The wedge geometry mold is about 300 mm long, 40 mm wide and 50 mm deep. The cupcake shape mold has the 15 mm cavity depth.

As shown in Table 2, all samples have areal density and ash content close to target value of 1118 gsm, but sample RH20 had areal density in the higher end as compared to target. The S-LWRT without containing the two natural fiber had areal density and ash in target range. Hence, this indicated the ratios between glass and natural fibers and PP resin were made successfully as designed. The as-produced thicknesses of the two rice hull ground based biocomposite samples, RH10 and RH20, are similar as the stand LWRT (S-LWRT) without natural fiber, while the two kenaf fiber based biocomposite samples, KF10 and KF20, have higher thickness likely due to the higher volume density of kenaf fiber.

TABLE 2

| | Areal density | Thickness | Density | Ash |
|---|---|---|---|---|
| Sample | (gsm) | (mm) | (g/cm³) | (%) |
| RH10 | 1113 ± 19 | 3.2 ± 0.1 | 0.34 ± 0.00 | 41.3 ± 0.6 |
| RH20 | 1158 ± 8 | 3.4 ± 0.1 | 0.34 ± 0.01 | 37.1 ± 0.7 |
| KF10 | 1129 ± 14 | 4.4 ± 0.1 | 0.26 ± 0.01 | 40.7 ± 0.2 |
| KF20 | 1137 ± 8 | 4.3 ± 0.1 | 0.26 ± 0.01 | 28.6 ± 0.3 |
| S- | 1134 ± 4 | 3.6 ± 0.1 | 0.32 ± 0.00 | 49.1 ± 0.2 |
| LWRT | | | | |

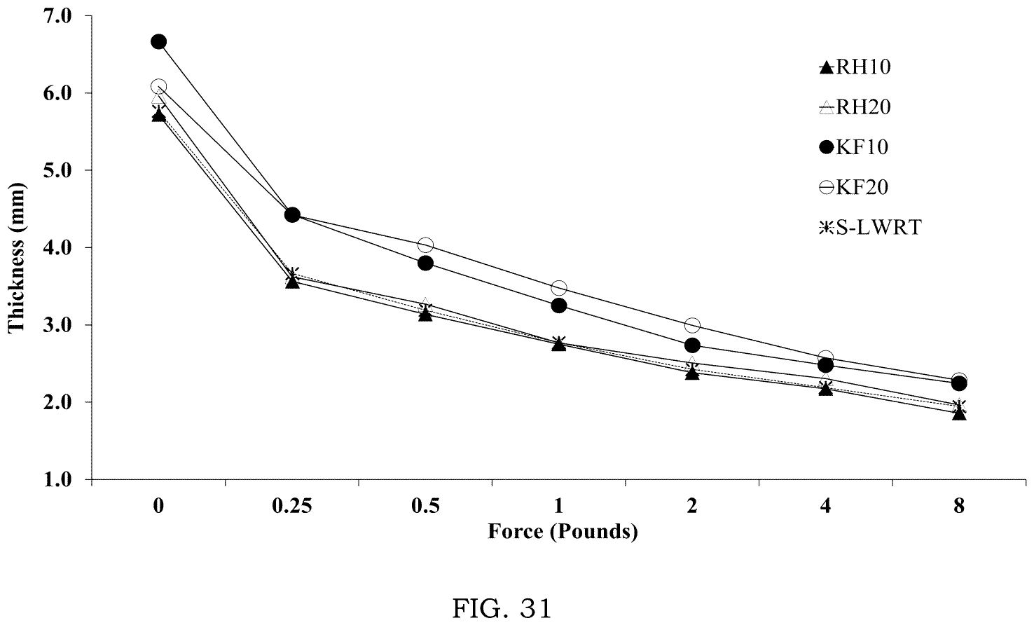

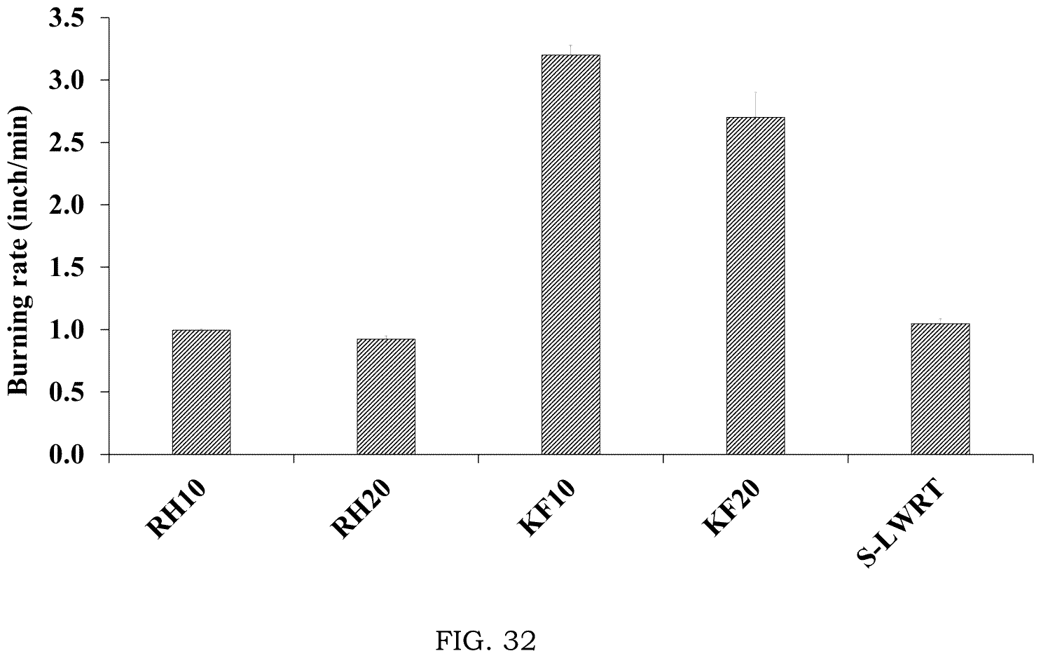

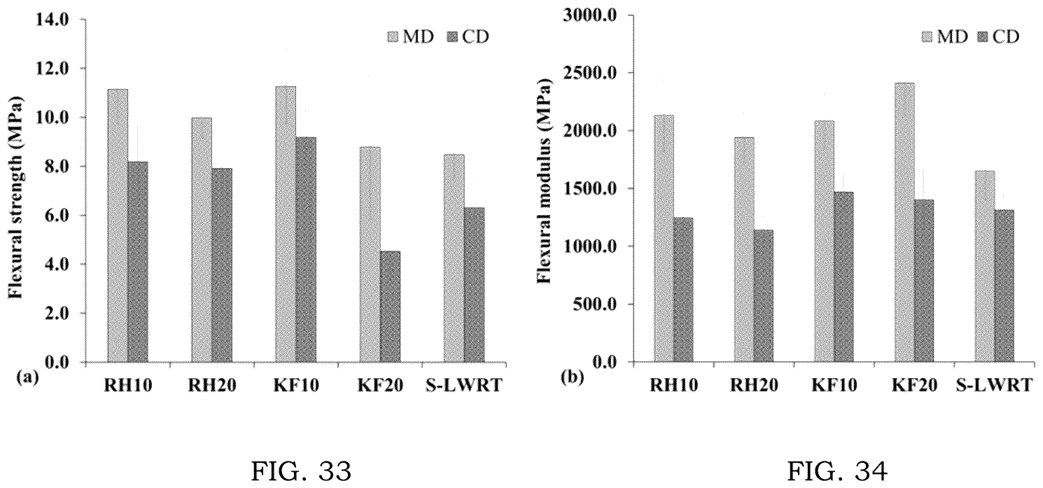

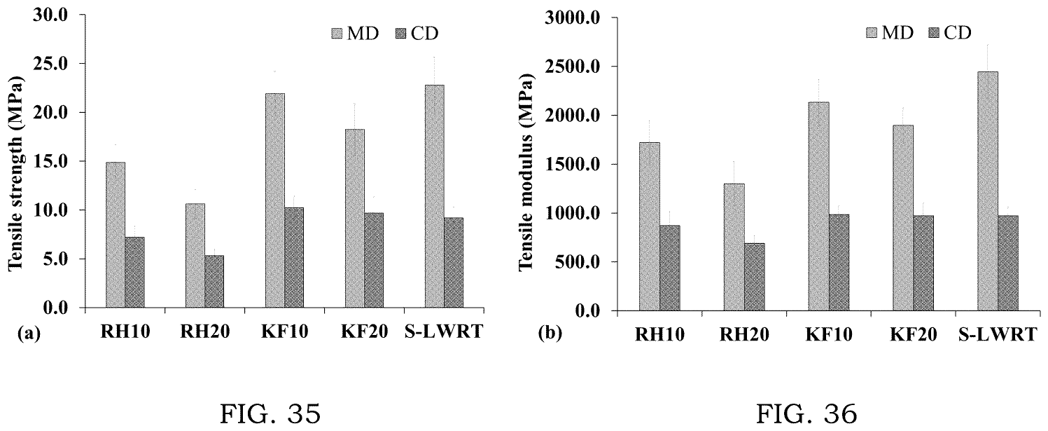

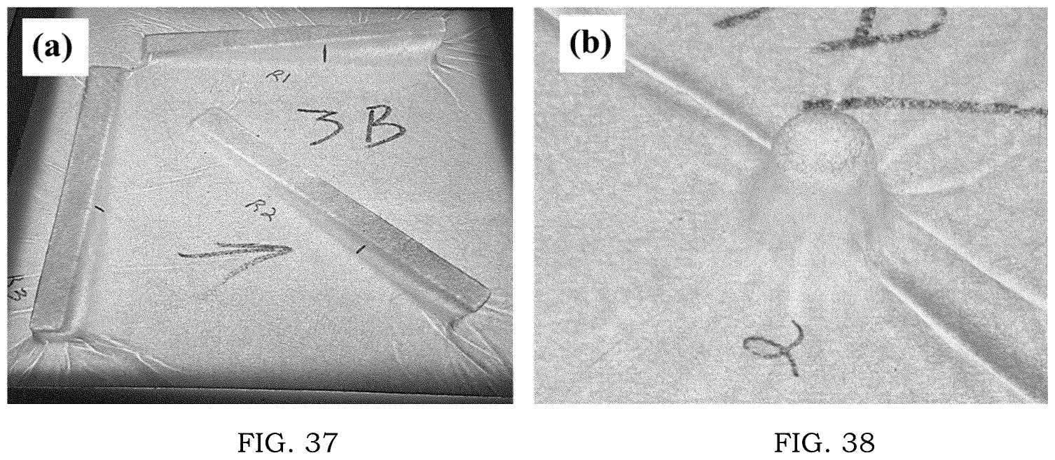

FIG. 31 compares the resistance to compression performances of biocomposite samples and the standard LWRT composite. Free loft thickness (0 pound) of these composites ranged from 5.8 mm to 6.8 mm as compared to the as-produced thickness ranging from 3.2 mm to 4.4 mm (Table 2). Kenaf fibers included biocomposite (KF10 and KF20) had higher resistance to compression than the rice hull ground based biocomposite and the standard LWRT composite. The rice hull ground based biocomposite samples (RH10 and RH20) had similar resistance to compression as the standard LWRT composite (S-LWRT). These findings indicate that these biocomposites exhibit comparable or improved moldability compared to the standard LWRT composite.

The objective of flammability test following FMVSS 302 standard is to reduce the risk of fire in vehicle cabins by establishing certain performance requirements for the flammability of materials used in the interior of passenger cars, multipurpose passenger vehicles, trucks, and buses. Under FMVSS 302, automotive interior materials, including headliners, must meet specific criteria for flammability. The standard specifies a test method known as the “Horizontal Burning Rate Test” to assess the material's resistance to ignition and the rate at which it burns. FIG. 32 shows the burning rate of molded standard LWRT (S-LWRT) without natural fiber and the four biocomposite samples. The rice hull ground contained samples showed lower burning rate than the S-LWRT and the two kenaf fibers included samples (KF10 and KF20). This is contributed to the higher amount of silicon dioxide (SiO2) content of rice hull which inherently fire-resistance and acts as a barrier against heat transfer [10]. Comparing RH10 with RH20 or KF10 with KF20, it can be seen adding more of the rice hull or kenaf fiber did not increase the burning rate. Kenaf fibers based biocomposite samples (KF10 and KF20) have higher burning rate than the standard LWRT and rice hulls based samples. This is because kenaf fiber contains higher cellulose which is more flammable than glass fiber and rice hulls. However, all these materials showed acceptable burning rate as automotive interior applications.

Flexural strength and modulus of these biocomposite sample and the standard LWRT are shown in FIG. 33 and FIG. 34. In both the machine direction (MD—same direction as the moving support moves) and CD (cross direction—orthogonal to the machine direction), 10% rice hull ground (RH10) showed about 30% higher flexural strength than the standard LWRT (S-LWRT) without natural fiber. The 20% rice hull ground based sample (RH20) had 18% and 26% higher flexural strength in MD and CD, respectively, than the S-LWRT material. This suggested incorporating rice hull ground had benefits in improving the flexural properties as compared to S-LWRT. In a study conducted by Hidalgo-Salazar et al., they examined the effects of incorporating RH into a PP composite. The results showed a notable 75% increase in flexural strength for the RH/PP composite compared to pure PP. The researchers attributed this enhancement in bending properties to the stiffening influence of the rice hulls within the PP matrix. Therefore, the inclusion of rice hull a reinforcing material led to improved flexural strength in the composite, surpassing that of standard LWRT composite. The 10% kenaf fiber based sample (KF10) had 18% and 26% higher flexural strength in MD and CD, respectively, than the S-LWRT material. 20% kenaf fiber included sample (KF20) showed similar strength in MD and 30% lower of flexural strength in CD as compared to the S-LWRT composite material. The more kenaf fibers did not increase the flexural strength furthermore, which was likely due to the relatively poorer dispersion of the fiber. The lower strength of this KF20 was likely due to the orientation of the fiber was mostly parallel to the machine direction.

The flexural modulus of a composite material consisting of natural fibers or glass fibers and polypropylene (PP) can be influenced by several factors. Some of the key factors include: fiber orientation, fiber content, fiber-matrix adhesion, fiber length and aspect ratio, fiber type and properties, matrix polymer properties, and processing conditions as well. As shown in FIG. 3(b), the introduction of rice hull ground and kenaf fibers did not lead to a deterioration of the modulus when compared to the standard LWRT. In the machine direction (MD), all biocomposite samples exhibited a higher modulus than the standard LWRT. For example, the KF20 sample had 46% higher modulus than the S-LWRT material. This indicated the addition of 20% kenaf fiber was able to increase the LWRT stiffness significantly. However, in the cross-machine direction (CD), the rice hull-based composites RH10 and RH20 displayed a lower modulus. The kenaf fiber-based samples KF10 and KF20 demonstrated just slightly higher modulus values compared to the standard LWRT, which again could be due to the fiber orientation.

Tensile results of these biocomposite and the standard LWRT composite are shown in FIG. 35 and FIG. 36. Adding rice hull ground decrease the tensile strength and modulus from standard LWRT composite. The KF10 sample containing 10% kenaf fiber showed similar tensile strength as the S-LWRT composite in MD, while the tensile strength tested in CD was about 10% higher than the S-LWRT. The KF20 sample showed tensile strength and modulus in MD than the S-LWRT composite. This KF20 sample had similar tensile strength and modulus in CD as the S-LWRT composite. Previous researches showed adding kenaf fiber the resultant composite showed higher tensile strength than the neat PP [9]. These replacing glass fiber with rice hull ground or kenaf fiber in RH10, RH20 and RH20 biocomposites deteriorated the tensile properties as compared to standard LWRT composite.

very important characteristic of the standard LWRT sheet is its formability. The torture tool molds were specifically designed to simulate the most critical shape changes that automotive part components undergo during the thermoforming process. In order to investigate the formability of the biocomposite made from rice hulls and kenaf fibers the flat sheets were subjected to a thermoforming processes to create parts with varied geometries, such as the wedge and cupcake shapes. FIG. 37 and FIG. 38 show two examples of the shapes of wedge (FIG. 37) and cupcakes (FIG. 38) of the rice hull ground included sample RH20. By quantitative analysis, the addition of natural fibers did not deteriorate the thermoformability as compared to standard LWRT composite sheets.

The results showed successful formulation of the ratios between fibers and resin, with the biocomposites exhibiting comparable areal density and ash content. Kenaf fiber based biocomposites demonstrated higher resistance to compression and flexural strength, while rice hull ground based biocomposites exhibited lower burning rates and improved flexural strength compared to the standard LWRT. The addition of natural fibers did not significantly affect thermoformability, but it led to decreased tensile properties in some formulations.

### Example 2

Additional specimens were produced in a similar manner as described in Example 1. The additional specimens are shown in Table 3 below. GF represents glass fibers, PP represents polypropylene, and PET represent polyethylene terephthalate.

TABLE 3

| | Core | | |
|---|---|---|---|
| | gsm | | |
| Formulation | (g/m²) | Skins | Color |
| SL-5151 (control): 55% GF + 45% | 1000 | 88 gsm film + | Black |
| PP resin | | 20 gsm scrim | |
| ST-14770: 45% GF + 45% PP resin + | 1000 | 98 gsm film + | Natural |
| 10% Rice Hull | | 20 gsm scrim | |
| ST-14771: 45% GF + 45% PP resin + | 1100 | 98 gsm film + | Natural |
| 10% Rice Hull | | 20 gsm scrim | |
| ST-14772: 40% GF + 40% PP resin + | 1000 | 98 gsm film + | Natural |
| 20% Rice Hull | | 20 gsm scrim | |
| ST-14773: 40% GF + 40% PP resin + | 1100 | 98 gsm film + | Natural |
| 20% Rice Hull | | 20 gsm scrim | |

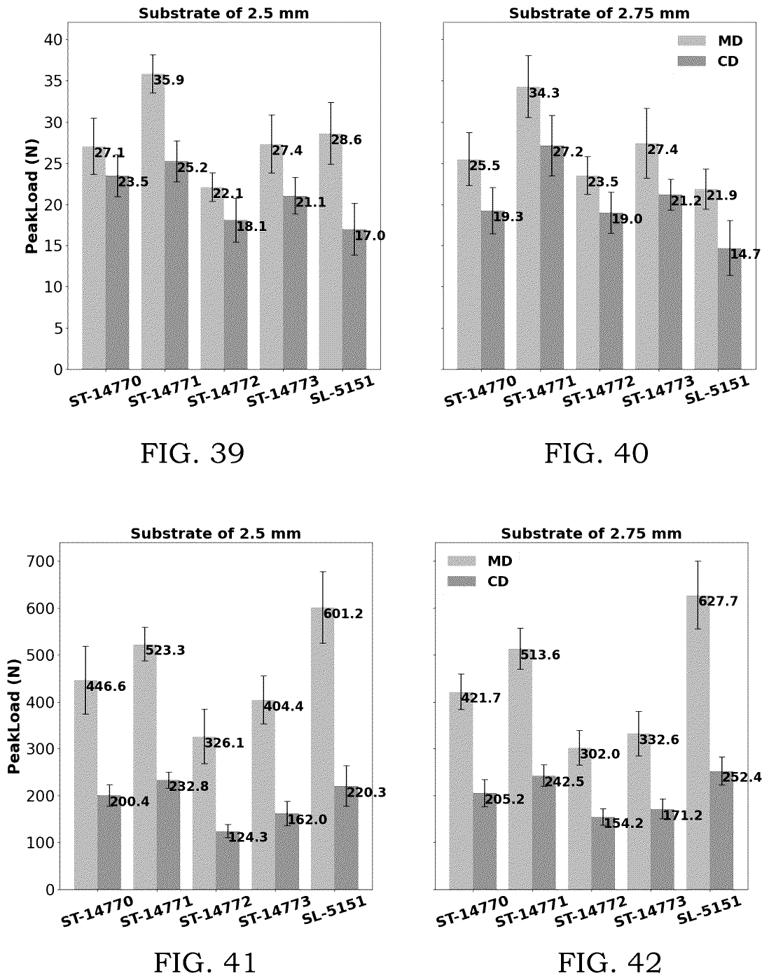

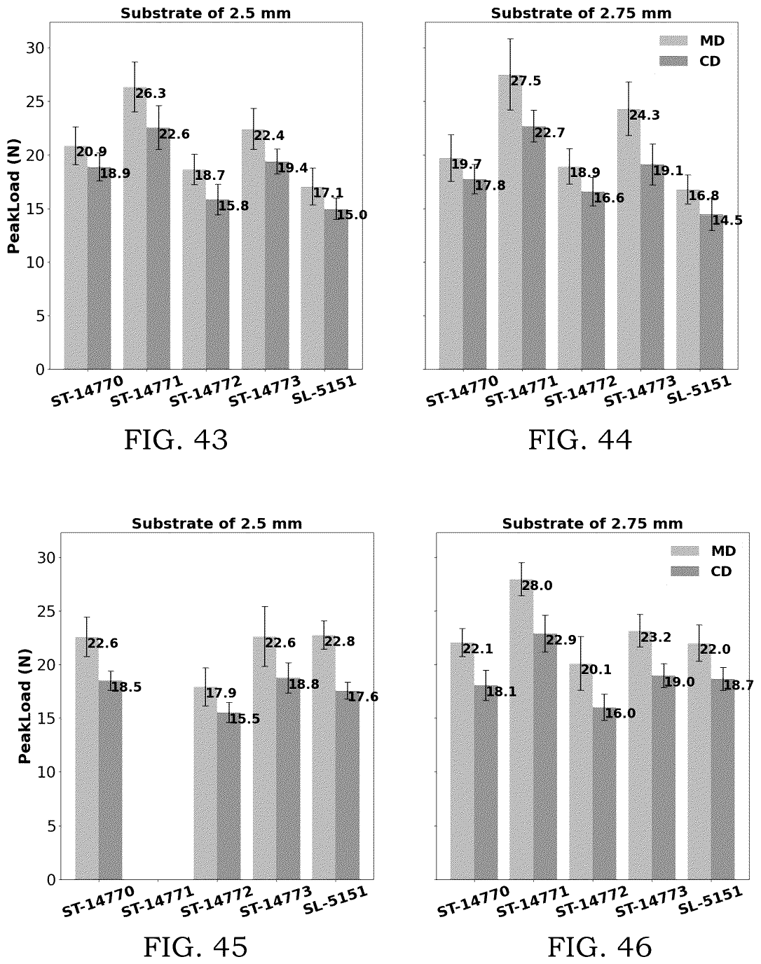

The test results are shown in FIGS. 39-42 with FIGS. 39 and 40 showing ISO-Flex peak load for different substrate thicknesses (2.5 mm and 2.75 mm), and FIGS. 41 and 42 showing ISO Tensile peak load for different substrate thicknesses (2.5 mm and 2.75 mm). The left bar in each bar graph grouping shows the machine direction values, and the right bar in each bar graph grouping shows the cross direction values. Compared to the control values (SL-5151), the test specimens exhibit similar or better ISO-flex peak load in both the machine and cross directions. ISO-tensile peak load for the test specimens was lower or the same as the control values.

Additional measurements were performed on the test specimens of Table 3 including SAE flex peak load for substrate only (FIGS. 43 and 44) and SAE flex peak load for substrate attached with fabric (FIGS. 45 and 46). In the examples herein, SAE flex peak load was measured according to SAEJ949 as revised in 2009. For the substrate only specimens (FIGS. 43 and 44), SAE flex peak load was similar or better than control values. For the substrate+fabric specimens (FIGS. 45 and 46), SAE flex peak load was similar or better than control values. In FIG. 45, no data was obtained for the ST-14771 article at 2.5 mm substrate thickness due to the limited availability of the material. These results are consistent with the rice hull materials providing similar or better performance than control materials which lacked the rice hull materials.

### Example 3

6 mm kenaf fibers were added into two test specimens as indicated in Table 4 below. A control (SL-3020) specimen was used for comparison. Test thicknesses were 2.5 mm and 2.75 mm.

TABLE 4

| | Core gsm | | |
|---|---|---|---|
| Formulation | (g/m²) | Skins | Color |
| SL-3020 (control): 55% glass | 1000 | 40 gsm film + | Natural |
| fibers + 45% PP resin | | 17 gsm scrim | |
| ST-14823: 45% glass fibers + 45% | 1000 | 98 gsm film + | Natural |
| PP resin + 10% Kenaf fibers | | 20 gsm scrim | |
| ST-14824: 35% glass fibers + 45% | 1000 | 98 gsm film + | Natural |
| PP Resin + 20% Kenaf fibers | | 20 gsm scrim | |

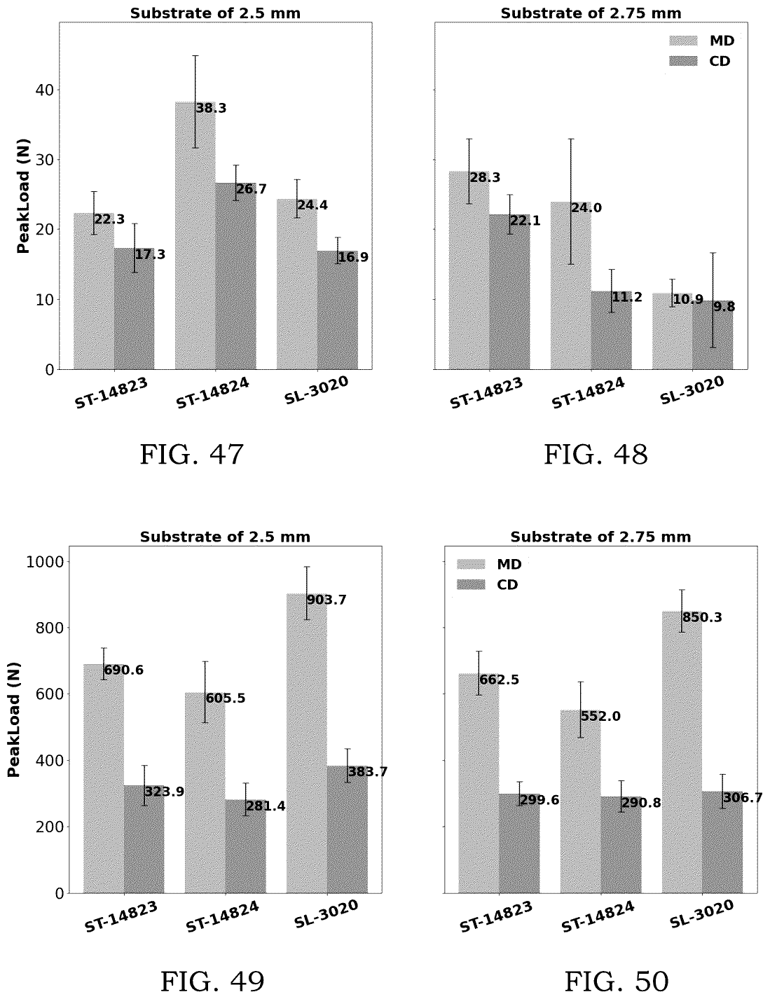

ISO-flex peak load (FIGS. 47 and 48), ISO-tensile peak load (FIGS. 49 and 50), and SAE-flex peak load (FIGS. 51 and 52) were measured. The left bar in each bar graph grouping shows the machine direction values, and the right bar in each bar graph grouping shows the cross direction values. ISO-flex peak load values (FIGS. 47 and 48) for the test specimens were similar or better than control values in both the machine and cross directions. Higher Kenaf fiber loading (ST-14824) improved the ISO-flex peak load values at lower substrate thickness. ISO-tensile peak load values were similar or slightly lower for the test specimens compared to the control values. SAE flex peak load values were similar or better for the test specimens at both substrate thicknesses. These results are consistent with the Kenaf fibers providing similar or better performance as specimens lacking the Kenaf fibers.

### Example 4

Several test specimens including both rice hulls and recycled PET fibers were produced and compared to control specimens as shown in Table 5.

TABLE 5

| | Core gsm | | |
|---|---|---|---|
| Formulation | (g/m²) | Skins | Color |
| SL-4062 (control): 55% glass | 1000 | 40 gsm film + | Black |
| fibers + 45% PP resin | | 17 gsm scrim | |
| SL-3751 (control): 55% glass | 1000 | 70 gsm film + | Black |
| fibers + 45% PP resin | | 20 gsm scrim | |
| ST-14896: 35% glass fibers + | 1000 | 60 gsm film + | Black |
| 40% PP resin + 20% Rice hull + | | 20 gsm scrim | |
| 5% recycled PET fibers. | | | |
| ST-14897: 30% glass fibers + | 1000 | 60 gsm film + | Black |
| 40% PP resin + 20% Rice hull + | | 20 gsm scrim | |
| 10% recycled PET fibers. | | | |

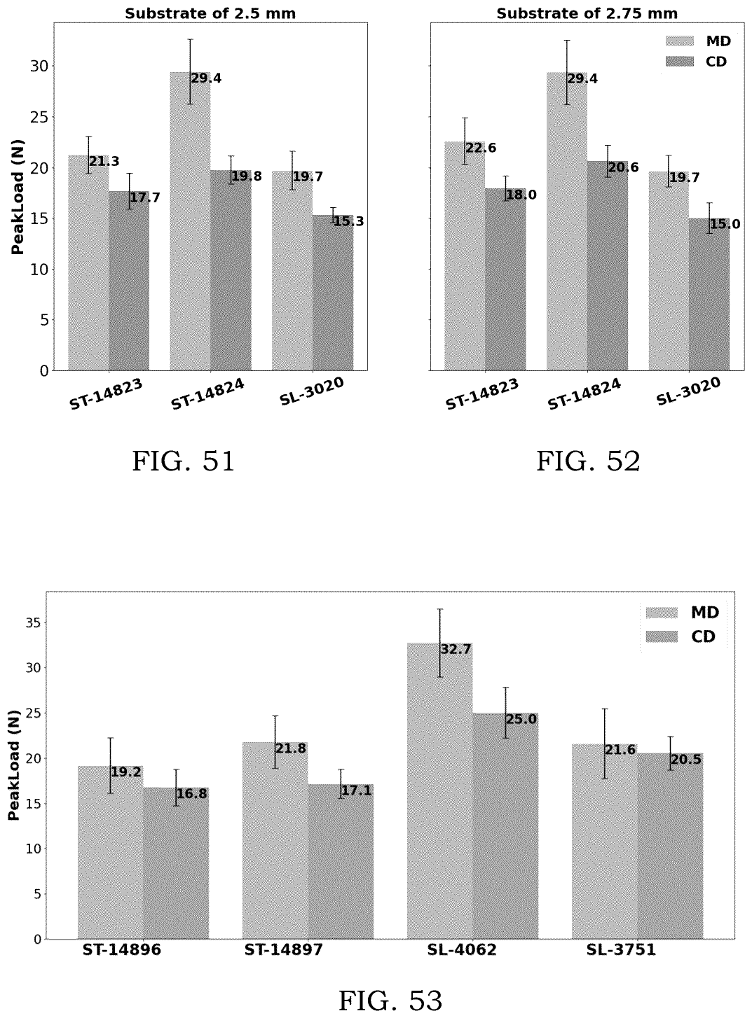

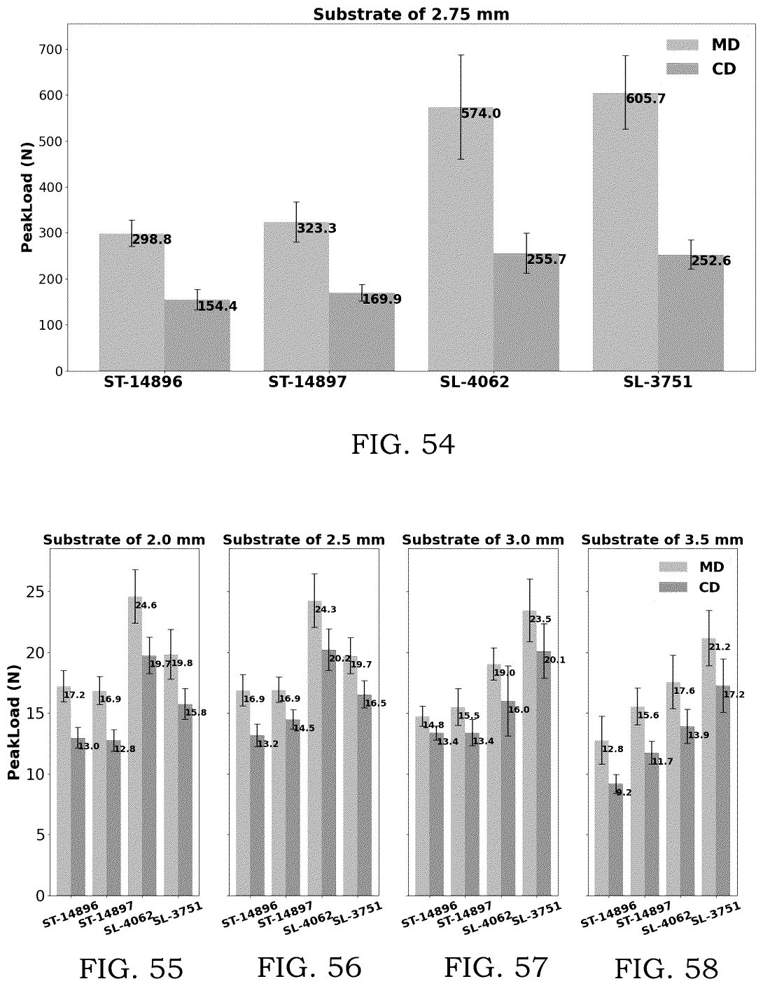

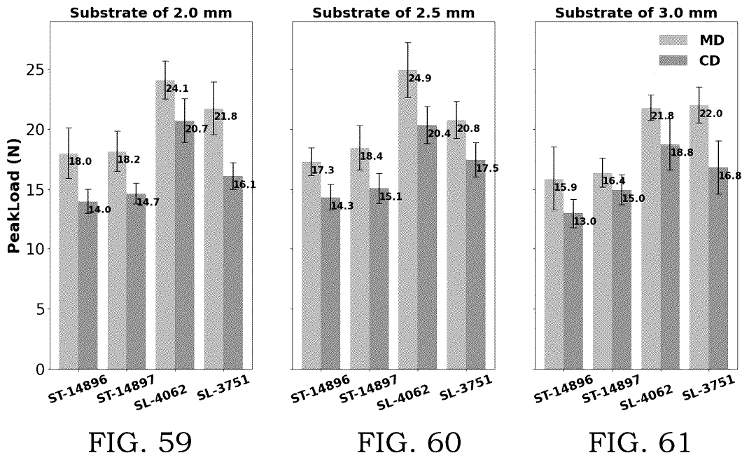

The test results are shown in FIGS. 53-61 with FIGS. 53 and 54 showing ISO-Flex peak load and ISO-Tensile peak load, respectively, for different substrate thicknesses (2.5 mm in FIG. 53 and 2.75 mm in FIG. 54). FIGS. 55-61 show SAE-flex peak load for different substrate thicknesses without any attached fabric (FIGS. 55-58) and with attached fabric (FIG. 59-61).

Compared to control values, the ISO-flex peak load values (FIG. 53) for test specimens were similar or better in both the machine and cross-direction values. ISO-tensile peak load values (FIG. 54) were lower than the control values. For SAE-flex peak load values generally decreased as substrate thickness increased. This trend occurred for samples without fabric and for samples with fabric. The presence of absence of the fabric did not substantially alter the SAE-flex peak load values for test or control specimens.

When introducing elements of the examples disclosed herein, the articles “a,” “an,” “the” and “said” are intended to mean that there are one or more of the elements. The terms “comprising,” “including” and “having” are intended to be open-ended and mean that there may be additional elements other than the listed elements. It will be recognized by the person of ordinary skill in the art, given the benefit of this disclosure, that various components of the examples can be interchanged or substituted with various components in other examples.

Although certain aspects, configurations, examples and embodiments have been described above, it will be recognized by the person of ordinary skill in the art, given the benefit of this disclosure, that additions, substitutions, modifications, and alterations of the disclosed illustrative aspects, configurations, examples and embodiments are possible.

1. A thermoplastic composite article comprising:
a porous core layer comprising a web of open celled structures comprising a plurality of biomaterials and random crossing over of a plurality of reinforcing fibers held together by a thermoplastic material; and
a skin layer disposed on a first surface of the porous core layer.

2. The thermoplastic composite article of claim 1, wherein the plurality of biomaterials are bioparticles selected from the group consisting of particles from ground and sized rice hulls, coconut shells, coffee bean grounds, coffee chaff, wheat hulls, corn hulls, wood particles, plant byproducts and combinations thereof.

3. The thermoplastic composite article of claim 1, wherein the plurality of reinforcing fibers comprise recycled fibers.

4. The thermoplastic composite article of claim 1, wherein the plurality of biomaterials are biofibers comprising fibers produced from one or more of ground and sized rice hulls, coconut shells, coffee bean grounds, coffee chaff, wheat hulls, corn hulls, wood particles, plant byproducts or combinations thereof.

5. The thermoplastic composite article of claim 1, wherein the thermoplastic material comprises thermoplastic material particles, and wherein the bioparticles comprises an average particle diameter about the same as an average particle diameter of the thermoplastic material particles.

6. The thermoplastic composite article of claim 5, wherein the average particle diameter is about 50 microns to about 2 mm.

7. The thermoplastic composite article of claim 1, wherein the plurality of bioparticles comprise an inorganic content of at least 10 weight percent based on the weight of the plurality of bioparticles.

8. The thermoplastic composite article of claim 7, wherein the plurality of bioparticles comprise silica.

9. The thermoplastic composite article of claim 1, wherein the plurality of bioparticles are distributed homogeneously throughout the porous core layer or wherein the plurality of bioparticles impart a texture to the first surface of the porous core layer.

10. The thermoplastic composite article of claim 1, wherein the plurality of bioparticles are present in the porous core layer from about 1 weight percent to about 20 weight percent based on the weight of the porous core layer.

11. The thermoplastic composite article of claim 1, wherein the thermoplastic material of the porous core layer comprises a virgin polyolefin material or a recycled polyolefin material or both, the plurality of reinforcing fibers of the porous core layer comprise glass fibers, and the biomaterials of the porous core layer are bioparticles selected from the group consisting of particles from ground and sized rice hulls, coconut shells, coffee bean grounds, coffee chaff, wheat hulls, corn hulls, wood particles, plant byproducts and combinations thereof.

12. The thermoplastic composite article of claim 1, wherein the thermoplastic material of the porous core layer comprises virgin thermoplastic material, recycled thermoplastic material or both, and wherein the virgin thermoplastic material or recycled thermoplastic material is independently at least one of a polyethylene, a polypropylene, a polystyrene, a polyimide, a polyetherimide, an acrylonitrylstyrene, a butadiene, a polyethyleneterephthalate, a polybutyleneterephthalate, a polybutylenetetrachlorate, a polyvinyl chloride, a polyphenylene ether, a polycarbonate, a polyestercarbonate, a polyester, an acrylonitrile-butylacrylate-styrene polymer, an amorphous nylon, a polyarylene ether ketone, a polyphenylene sulfide, a polyaryl sulfone, a polyether sulfone, a poly(1,4 phenylene) compound, a silicone and mixtures thereof.

13. The thermoplastic composite article of claim 1, wherein the plurality of reinforcing fibers of the porous core layer are selected from the group consisting of glass fibers, carbon fibers, graphite fibers, synthetic organic fibers, inorganic fibers, natural fibers, mineral fibers, metal fibers, metalized inorganic fibers, metalized synthetic fibers, ceramic fibers, and combinations thereof.

14. The thermoplastic composite article of claim 1, wherein the plurality of reinforcing fibers comprise reproduced fibers.

15. The thermoplastic composite article of claim 1, wherein the skin layer is selected from the group consisting of a fabric, a film, a scrim, a frim, a porous non-woven material, a porous knit material, a decorative layer, and combinations thereof.

16. The thermoplastic composite article of claim 1, wherein the thermoplastic composite article is constructed and arranged as an interior automotive part, interior automotive trim, an automotive headliner, an interior recreational vehicle panel or an interior recreational vehicle part.

17. The thermoplastic composite article of claim 1, further comprising a biocidal agent or a lofting agent in the porous core layer.

18. The thermoplastic composite article of claim 1, wherein the skin layer comprises a plurality of biofibers.

19. The thermoplastic composite article of claim 18, wherein the plurality of biofibers in the skin layer are biofibers selected from the group consisting of fibers produced from ground and sized rice hulls, coconut shells, coffee bean grounds, coffee chaff, wheat hulls, corn hulls, wood particles, plant byproducts and combinations thereof.

20. The thermoplastic composite article of claim 1, wherein the thermoplastic material comprises a virgin polyolefin material or a recycled polyolefin material or both, the plurality of reinforcing fibers comprise biofibers, and the plurality of biomaterials are bioparticles selected from the group consisting of particles from ground and sized rice hulls, coconut shells, coffee bean grounds, coffee chaff, wheat hulls, corn hulls, wood particles, plant byproducts and combinations thereof.

21-39. (canceled)
